(19) United States
(12) Patent Application Publication
(10) Pub. No.: US 2023/0015569 A1
(43) Pub. Date: Jan. 19, 2023

(54) DATA STRUCTURE FOR EFFICIENTLY VERIFYING DATA

(71) Applicant: nChain Holdings Limited, St. John's (AG)

(72) Inventors: Jack Owen DAVIES, London (GB); Daniel JOSEPH, Cardiff (GB); Craig Steven WRIGHT, London (GB)

(21) Appl. No.: 17/771,404

(22) PCT Filed: Oct. 12, 2020
(86) PCT No.: PCT/IB2020/059558

§ 371 Date: Apr. 22, 2022

(30) Foreign Application Priority Data
Oct. 24, 2019 (GB) 1915443.4

(51) Int. Cl. G06Q 20/38; G06Q 20/40

(52) U.S. Cl. CPC G06Q 20/3827; G06Q 20/38215; G06Q 20/4014

(57) ABSTRACT

A data structure embodied in one or more blockchain transactions has a plurality of nodes, each node embodied as a hash value contained in a blockchain transaction of the one or more blockchain transactions; and a plurality of directional edges plurality of nodes comprises leaf nodes and non-leaf nodes. In a first aspect, at least one of the non-leaf nodes has at least one child leaf node and at least one child non-leaf node, the hash value of the at least one non-leaf node being a hash of a concatenation of the respective hash values of the child leaf node and the child non-leaf node. In a second aspect, a first of the non-leaf nodes has a different number of child nodes than a second of the non-leaf nodes. In a third aspect, a first of the leaf nodes has a different level than a second of the leaf nodes.

### CROSS REFERENCE TO RELATED APPLICATIONS

This application is the U.S. National Stage of International Application No. PCT/lB2020/059558 filed on Oct. 12, 2020, which claims the benefit of United Kingdom Patent Application No. 1915443.4, filed on Oct. 24, 2019, the contents of which are incorporated herein by reference in their entireties.

### TECHNICAL FIELD

The present disclosure pertains to an improved hash tree data structure used in a blockchain context, where the data structure represents an underlying set of data blocks, and may be used to efficiently verify a received data block, i.e. to determine whether or not the received data block corresponds to a particular data block of the underling set of data blocks.

### BACKGROUND

A blockchain refers to a form of distributed data structure, wherein a duplicate copy of the blockchain is maintained at each of a plurality of nodes in a peer-to-peer (P2P) network. The blockchain comprises a chain of blocks of data, wherein each block comprises one or more transactions. Each transaction may point back to a preceding transaction in a sequence which may span one or more blocks. Transactions can be submitted to the network to be included in new blocks. New blocks are created by a process known as “mining”, which involves each of a plurality of mining nodes competing to perform “proof-of-work”, i.e. solving a cryptographic puzzle based on a pool of the pending transactions waiting to be included in blocks.

Conventionally the transactions in the blockchain are used to convey a digital asset, i.e. data acting as a store of value. However, a blockchain can also be exploited in order to layer additional functionality on top of the blockchain. For instance, blockchain protocols may allow for storage of additional user data in an output of a transaction. Modern blockchains are increasing the maximum data capacity that can be stored within a single transaction, enabling more complex data to be incorporated. For instance this may be used to store an electronic document in the blockchain, or even audio or video data.

Each node in the network can have any one, two or all of three roles: forwarding, mining and storage. Forwarding nodes propagate transactions throughout the nodes of the network. Mining nodes perform the mining of transactions into blocks. Storage nodes each store their own copy of the mined blocks of the blockchain. In order to have a transaction recorded in the blockchain, a party sends the transaction to one of the nodes of the network to be propagated. Mining nodes which receive the transaction may race to mine the transaction into a new block. Each node is configured to respect the same node protocol, which will include one or more conditions for a transaction to be valid. Invalid transactions will not be propagated nor mined into blocks. Assuming the transaction is validated and thereby accepted onto the blockchain, then the transaction (including any user data) will thus remain stored at each of the nodes in the P2P network as an immutable public record.

The miner who successfully solved the proof-of-work puzzle to create the latest block is typically rewarded with a new transaction called a “generation transaction” which generates a new amount of the digital asset. The proof-of work incentivises miners not to cheat the system by including double-spending transactions in their blocks, since it requires a large amount of compute resource to mine a block, and a block that includes an attempt to double spend is likely not be accepted by other nodes.

In an “output-based” model (sometimes referred to as a UTXO-based model), the data structure of a given transaction comprises one or more inputs and one or more outputs. Any spendable output comprises an element specifying an amount of the digital asset, sometimes referred to as a UTXO (“unspent transaction output”). The output may further comprise a locking script specifying a condition for redeeming the output. Each input comprises a pointer to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the P2P network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it nor include it for mining into a block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the miners separate to the blockchain and is updated constantly. The state is modified by running smart-contracts which are included in transactions and run when the transactions are validated by nodes of the blockchain network.

Certain implementations of blockchain utilize “hash trees” or “Merkle trees” as an efficient means of representing a set of transactions contained in a block. A hash tree is a specific form of data structure having a set of nodes and edges between the nodes. A single one of the nodes is a root node to which all other nodes are directly or indirectly connected. In a binary tree, each node has exactly two child nodes. Each node has a level in the tree, which is the number of edges connecting it to the root node (itself at level zero). Each node at the lowest level of the tree (M) is a leaf node, which either represents a transaction stored in the block or some “padding” data required to preserve the structure of the tree. Each node representing a transaction has a value, which is a hash of the transaction it represents. All other nodes (i.e. at all levels less than M) are non-leaf nodes, each of which has a value computed by concatenating the values of its two child nodes, and hashing the resulting concatenated string. The root node “summarizes” the entire set of transactions in a cryptographically robust manner, and the value of the root node is included in the header of the block. Given a transaction to be verified, a “Merkle proof” can be performed in order to verify that the transaction belongs to the set of transactions represented by the Merkle tree in a computationally efficient manner. In short, this involves “reconstructing” the value of the root node using the received transaction and a minimum set of required node values from the hash tree, and comparing the reconstructed root node to the actual root node value stored in the block header. A transaction (or, more generally, data block) is said to belong to the hash tree if the Merkle proof is successful for that data block, which, in turn, implies that this data block belongs to the set of data blocks (e.g. transactions) used to construct the hash tree (regarding terminology, it is noted that the term “data block” refers to a set of data used to construct a root note or which is verified against a hash tree, which is of course distinct from a block of a blockchain in which blockchain transaction are recorded).

### SUMMARY

The present disclosure provides what is referred to herein as a “generalised hash tree data structure”. A generalised hash tree data structure is somewhat comparable to a “classical” hash tree of the kind summarized in the preceding paragraph. However, in contrast to classical hash trees, a generalised hash trees not only represents a set of data blocks but can also represent an external hierarchy of those data blocks. That is, a set of hierarchical relationships between the data blocks. Given a received data block, a generalised hash tree can not only be used to efficiently determine whether that received data block belongs to the generalised hash tree, but moreover can be used to verify its hierarchical relationship with the rest of the underlying data blocks. The ability to capture hierarchical relationships between data blocks in a generalised hash tree, and to verify those hierarchical relationships in a computationally efficient manner, has various practical applications, some examples of which are described below.

Aspects of the present disclosure provide a data structure embodied in one or more blockchain transactions held in transitory or non-transitory computer-readable media, the data structure having: a plurality of nodes, each node embodied as a hash value contained in a blockchain transaction of the one or more blockchain transactions; and a plurality of directional edges. The plurality of nodes comprises leaf nodes and non-leaf nodes, every non-leaf node having at least one child node directly connected thereto by a directional edge, and every child node being a non-leaf node or a leaf node without any child node connected thereto, the non-leaf nodes including a common root node to which all other nodes are connected directly or indirectly via one or more of the non-leaf nodes. The hash value of each non-leaf node is a hash of a concatenation of the hash values of all of its child node(s), and wherein the hash value of each leaf node is a hash of an external data block.

In a first such aspect of the present disclosure, at least one of the non-leaf nodes has at least one child leaf node and at least one child non-leaf node, the hash value of the at least one non-leaf node being a hash of a concatenation of the respective hash values of the child leaf node and the child non-leaf node. In a second aspect, a first of the non-leaf nodes has a different number of child nodes than a second of the non-leaf nodes. In a third aspect, a first of the leaf nodes has a different level than a second of the leaf nodes, the level of each node being the number of directional edges via which the node is directly or indirectly connected to the common root node.

Conventionally, in a blockchain context, hash trees are used to represent a set of transactions within a block. By contrast, the present generalised hash tree data structure is embodied in the one or more blockchain transactions themselves. That is, in a normal blockchain context, a Merkle tree conveys information about transactions, whereas in this case transactions are used to convey information about a Merkle tree. This provides a convenient way for blockchain users to immutably record hierarchical relationships between a set of data blocks (the “external hierarchy” according to the terminology used herein), in a way that admits cryptographically robust verification of not only the data blocks but also their hierarchical relationships, and without requiring the data blocks themselves to be revealed in the one or more transactions.

In preferred embodiments, the hash value of each leaf node may be a double hash or other multi-hash of the external data block (i.e. computed by the application of two or more successive hashing operations). This has the benefit that a party can provide a proof that they are in possession of the data block corresponding to a given leaf node by providing a single hash of the data block (in the case that double hashing is used to compute the value of each root node), and thus without revealing the data block itself. Such a proof may be published on the blockchain, e.g. in a subsequent transaction, in order to immutably record that proof in the blockchain, without revealing the underlying data.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 shows an example of a classical binary hash tree,

FIG. 4 shows an example of a binary Merkle tree having assigned node indices,

FIG. 5 shows an example of an authentication path for a given data block and a given classical hash tree,

FIG. 6 shows an example of a generalised hash tree,

FIG. 7 shows an example of a generalised Merkle tree with index tuples assigned to nodes,

FIG. 8 shows a branch of a second example generalised hash tree and illustrates how the values of nodes are computed via recursive computations,

FIG. 9 shows a modified generalised hash tree to which a new leaf node has been added,

FIG. 10 shows how a Merkle proof may be performed for a generalised hash tree,

FIG. 11 compares Merkle proof operations on a classical hash tree with Merkle proof operations in a generalised hash tree,

FIGS. 12A and 12B show a third example of a generalised hash tree,

FIG. 13 shows how the generalised hash tree of FIGS. 12A and 12B may be encoded in a set of blockchain transactions,

FIG. 14 shows an example of an off-chain system in which a generalised hash tree may be temporarily or permanently stored off-chain,

FIG. 15 shows a fourth example of a generalised hash tree representing a piece of digital content having discrete segments,

FIG. 16 shows a sub-tree for a given segment, and

FIG. 17 shows a modified generalised hash tree representing a re-edited piece of digital content.

### DETAILED DESCRIPTION OF EMBODIMENTS

### 1.1 Example System Overview

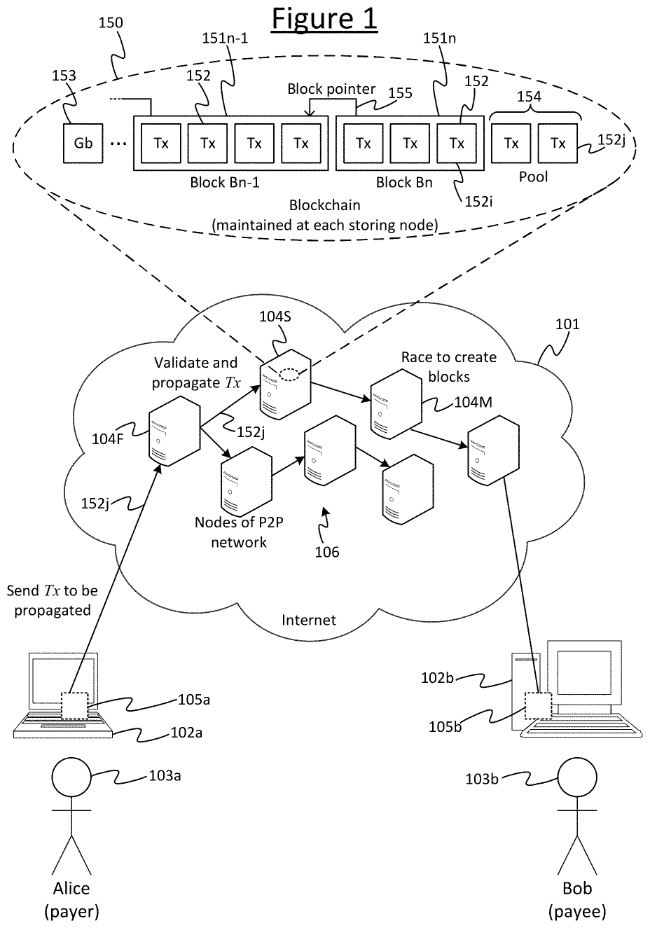

FIG. 1 shows an example system 100 for implementing a blockchain 150. The system 100 comprises a packet-switched network 101, typically a wide-area internetwork such as the Internet. The packet-switched network 101 comprises a plurality of nodes 104 arranged to form a peer-to-peer (P2P) overlay network 106 within the packet-switched network 101. Each node 104 comprises computer equipment of a peers, with different ones of the nodes 104 belonging to different peers. Each node 104 comprises processing apparatus comprising one or more processors, e.g. one or more central processing units (CPUs), accelerator processors, application specific processors and/or field programmable gate arrays (FPGAs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of nodes in the P2P network 160. Each block 151 in the chain comprises one or more transactions 152, wherein a transaction in this context refers to a kind of data structure. The nature of the data structure will depend on the type of transaction protocol used as part of a transaction model or scheme. A given blockchain will typically use one particular transaction protocol throughout. In one common type of transaction protocol, the data structure of each transaction 152 comprises at least one input and at least one output. Each output specifies an amount representing a quantity of a digital asset belonging to a user 103 to whom the output is cryptographically locked (requiring a signature of that user in order to be unlocked and thereby redeemed or spent). Each input points back to the output of a preceding transaction 152, thereby linking the transactions.

At least some of the nodes 104 take on the role of forwarding nodes 104F which forward and thereby propagate transactions 152. At least some of the nodes 104 take on the role of miners 104M which mine blocks 151. At least some of the nodes 104 take on the role of storage nodes 104S (sometimes also called “full-copy” nodes), each of which stores a respective copy of the same blockchain 150 in their respective memory. Each miner node 104M also maintains a pool 154 of transactions 152 waiting to be mined into blocks 151. A given node 104 may be a forwarding node 104, miner 104M, storage node 104S or any combination of two or all of these.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the pool 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the signature of the user 103a to whom the output of the preceding transaction 152i is locked. In turn, the output of the present transaction 152j can be cryptographically locked to a new user 103b. The present transaction 152j can thus transfer the amount defined in the input of the preceding transaction 152i to the new user 103b as defined in the output of the present transaction 152j. In some cases a transaction 152 may have multiple outputs to split the input amount between multiple users (one of whom could be the original user 103a in order to give change). In some cases a transaction can also have multiple inputs to gather together the amounts from multiple outputs of one or more preceding transactions, and redistribute to one or more outputs of the current transaction.

The above may be referred to as an “output-based” transaction protocol, sometimes also referred to as an unspent transaction output (UTXO) type protocol (where the outputs are referred to as UTXOs). A user's total balance is not defined in any one number stored in the blockchain, and instead the user needs a special “wallet” application 105 to collate the values of all the UTXOs of that user which are scattered throughout many different transactions 152 in the blockchain 151.

An alternative type of transaction protocol may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored by the miners separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

With either type of transaction protocol, when a user 103 wishes to enact a new transaction 152j, then he/she sends the new transaction from his/her computer terminal 102 to one of the nodes 104 of the P2P network 106 (which nowadays are typically servers or data centres, but could in principle be other user terminals). This node 104 checks whether the transaction is valid according to a node protocol which is applied at each of the nodes 104. The details of the node protocol will correspond to the type of transaction protocol being used in the blockchain 150 in question, together forming the overall transaction model. The node protocol typically requires the node 104 to check that the cryptographic signature in the new transaction 152j matches the expected signature, which depends on the previous transaction 152i in an ordered sequence of transactions 152. In an output-based case, this may comprise checking that the cryptographic signature of the user included in the input of the new transaction 152j matches a condition defined in the output of the preceding transaction 152i which the new transaction spends, wherein this condition typically comprises at least checking that the cryptographic signature in the input of the new transaction 152j unlocks the output of the previous transaction 152i to which the input of the new transaction points. In some transaction protocols the condition may be at least partially defined by a custom script included in the input and/or output. Alternatively it could simply be a fixed by the node protocol alone, or it could be due to a combination of these. Either way, if the new transaction 152j is valid, the current node forwards it to one or more others of the nodes 104 in the P2P network 106. At least some of these nodes 104 also act as forwarding nodes 104F, applying the same test according to the same node protocol, and so forward the new transaction 152j on to one or more further nodes 104, and so forth. In this way the new transaction is propagated throughout the network of nodes 104.

In an output-based model, the definition of whether a given output (e.g. UTXO) is spent is whether it has yet been validly redeemed by the input of another, onward transaction 152j according to the node protocol. Another condition for a transaction to be valid is that the output of the preceding transaction 152i which it attempts to spend or redeem has not already been spent/redeemed by another valid transaction. Again if not valid, the transaction 152j will not be propagated or recorded in the blockchain. This guards against double-spending whereby the spender tries to spend the output of the same transaction more than once. An account-based model on the other hand guards against double-spending by maintaining an account balance. Because again there is a defined order of transactions, the account balance has a single defined state at any one time.

In addition to validation, at least some of the nodes 104M also race to be the first to create blocks of transactions in a process known as mining, which is underpinned by “proof of work”. At a mining node 104M, new transactions are added to a pool of valid transactions that have not yet appeared in a block. The miners then race to assemble a new valid block 151 of transactions 152 from the pool of transactions 154 by attempting to solve a cryptographic puzzle. Typically this comprises searching for a “nonce” value such that when the nonce is concatenated with the pool of transactions 154 and hashed, then the output of the hash meets a predetermined condition. E.g. the predetermined condition may be that the output of the hash has a certain predefined number of leading zeros. A property of a hash function is that it has an unpredictable output with respect to its input. Therefore this search can only be performed by brute force, thus consuming a substantive amount of processing resource at each node 104M that is trying to solve the puzzle.

The first miner node 104M to solve the puzzle announces this to the network 106, providing the solution as proof which can then be easily checked by the other nodes 104 in the network (once given the solution to a hash it is straightforward to check that it causes the output of the hash to meet the condition). The pool of transactions 154 for which the winner solved the puzzle then becomes recorded as a new block 151 in the blockchain 150 by at least some of the nodes 104 acting as storage nodes 104S, based on having checked the winner's announced solution at each such node. A block pointer 155 is also assigned to the new block 151n pointing back to the previously created block 151n-1 in the chain. The proof-of-work helps reduce the risk of double spending since it takes a large amount of effort to create a new block 151, and as any block containing a double spend is likely to be rejected by other nodes 104, mining nodes 104M are incentivised not to allow double spends to be included in their blocks. Once created, the block 151 cannot be modified since it is recognized and maintained at each of the storing nodes 104S in the P2P network 106 according to the same protocol. The block pointer 155 also imposes a sequential order to the blocks 151. Since the transactions 152 are recorded in the ordered blocks at each storage node 104S in a P2P network 106, this therefore provides an immutable public ledger of the transactions.

Note that different miners 104M racing to solve the puzzle at any given time may be doing so based on different snapshots of the unmined transaction pool 154 at any given time, depending on when they started searching for a solution. Whoever solves their respective puzzle first defines which transactions 152 are included in the next new block 151n, and the current pool 154 of unmined transactions is updated. The miners 104M then continue to race to create a block from the newly defined outstanding pool 154, and so forth. A protocol also exists for resolving any “fork” that may arise, which is where two miners 104M solve their puzzle within a very short time of one another such that a conflicting view of the blockchain gets propagated. In short, whichever prong of the fork grows the longest becomes the definitive blockchain 150.

In most blockchains the winning miner 104M is automatically rewarded with a special kind of new transaction which creates a new quantity of the digital asset out of nowhere (as opposed to normal transactions which transfer an amount of the digital asset from one user to another). Hence the winning node is said to have “mined” a quantity of the digital asset. This special type of transaction is sometime referred to as a “generation” transaction. It automatically forms part of the new block 151n. This reward gives an incentive for the miners 104M to participate in the proof-of-work race. Often a regular (non-generation) transaction 152 will also specify an additional transaction fee in one of its outputs, to further reward the winning miner 104M that created the block 151n in which that transaction was included.

Due to the computational resource involved in mining, typically at least each of the miner nodes 104M takes the form of a server comprising one or more physical server units, or even whole a data centre. Each forwarding node 104M and/or storage node 104S may also take the form of a server or data centre. However in principle any given node 104 could take the form of a user terminal or a group of user terminals networked together.

The memory of each node 104 stores software configured to run on the processing apparatus of the node 104 in order to perform its respective role or roles and handle transactions 152 in accordance with the node protocol. It will be understood that any action attributed herein to a node 104 may be performed by the software run on the processing apparatus of the respective computer equipment. The node software may be implemented in one or more applications at the application layer, or a lower layer such as the operating system layer or a protocol layer, or any combination of these. Also, the term “blockchain” as used herein is a generic term that refers to the kind of technology in general, and does not limit to any particular proprietary blockchain, protocol or service.

Also connected to the network 101 is the computer equipment 102 of each of a plurality of parties 103 in the role of consuming users. These act as payers and payees in transactions but do not necessarily participate in mining or propagating transactions on behalf of other parties. They do not necessarily run the mining protocol. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective user party 103 to create, sign and send transactions 152 to be propagated throughout the network of nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the forwarding nodes 104F of the P2P network 106. This enables the wallet function of the client 105 to send transactions 152 to the network 106. The client 105 is also able to contact one, some or all of the storage nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. Each node 104 runs software configured to validate transactions 152 according to a node protocol, and in the case of the forwarding nodes 104F to forward transactions 152 in order to propagate them throughout the network 106. The transaction protocol and node protocol correspond to one another, and a given transaction protocol goes with a given node protocol, together implementing a given transaction model. The same transaction protocol is used for all transactions 152 in the blockchain 150 (though the transaction protocol may allow different subtypes of transaction within it). The same node protocol is used by all the nodes 104 in the network 106 (though it many handle different subtypes of transaction differently in accordance with the rules defined for that subtype, and also different nodes may take on different roles and hence implement different corresponding aspects of the protocol).

As mentioned, the blockchain 150 comprises a chain of blocks 151, wherein each block 151 comprises a set of one or more transactions 152 that have been created by a proof-of-work process as discussed previously. Each block 151 also comprises a block pointer 155 pointing back to the previously created block 151 in the chain so as to define a sequential order to the blocks 151. The blockchain 150 also comprises a pool of valid transactions 154 waiting to be included in a new block by the proof-of-work process. Each transaction 152 (other than a generation transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one of the one or more forwarding nodes 104F to which she is connected. E.g. this could be the forwarding node 104F that is nearest or best connected to Alice's computer 102. When any given node 104 receives a new transaction 152j, it handles it in accordance with the node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any storage node 104S that receives the transaction 152j will add the new validated transaction 152 to the pool 154 in the copy of the blockchain 150 maintained at that node 104S. Further, any forwarding node 104F that receives the transaction 152j will propagate the validated transaction 152 onward to one or more other nodes 104 in the P2P network 106. Since each forwarding node 104F applies the same protocol, then assuming the transaction 152j is valid, this means it will soon be propagated throughout the whole P2P network 106.

Once admitted to the pool 154 in the copy of the blockchain 150 maintained at one or more storage nodes 104, then miner nodes 104M will start competing to solve the proof-of-work puzzle on the latest version of the pool 154 including the new transaction 152 (other miners 104M may still be trying to solve the puzzle based on the old view of the pool 154, but whoever gets there first will define where the next new block 151 ends and the new pool 154 starts, and eventually someone will solve the puzzle for a part of the pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different nodes 104 may receive different instances of a given transaction first and therefore have conflicting views of which instance is ‘valid’ before one instance is mined into a block 150, at which point all nodes 104 agree that the mined instance is the only valid instance. If a node 104 accepts one instance as valid, and then discovers that a second instance has been recorded in the blockchain 150 then that node 104 must accept this and will discard (i.e. treat as invalid) the unmined instance which it had initially accepted.

1.2 UTXO-Based Model

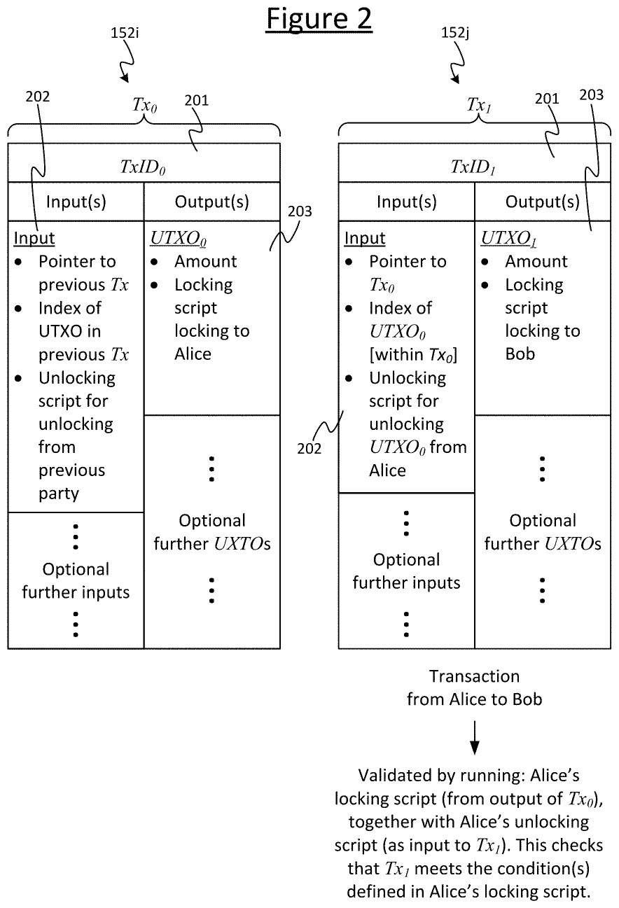

FIG. 2 illustrates an example transaction protocol. This is an example of an UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this not limiting to all possible embodiments.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO specifies an amount of a digital asset (a store of value). It may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the miners 104M.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just an arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in the blockchain 150 at the time when Alice creates her new transaction Tx₁, or at least by the time she sends it to the network 106. It may already have been included in one of the blocks 151 at that time, or it may be still waiting in the pool 154 in which case it will soon be included in a new block 151. Alternatively Tx₀ and Tx₁ could be created and sent to the network 102 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given node 104. Nevertheless, a subsequent transaction (the descendent transaction or “child”) which points to a preceding transaction (the antecedent transaction or “parent”) will not be validated until and unless the parent transaction is validated. A child that arrives at a node 104 before its parent is considered an orphan. It may be discarded or buffered for a certain time to wait for the parent, depending on the node protocol and/or miner behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S). The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains the public key P_{A} from a public-private key pair of Alice. The input 202 of Tx₁ comprises a pointer pointing back to Tx₁ (e.g. by means of its transaction ID, Tx1 Do, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script<Sig P_{A}> which comprises a cryptographic signature of Alice, created by Alice applying her private key from the key pair to a predefined portion of data (sometimes called the “message” in cryptography). What data (or “message”) needs to be signed by Alice to provide a valid signature may be defined by the locking script, or by the node protocol, or by a combination of these.

When the new transaction Tx₁ arrives at a node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>∥[Checksig P_{A}]

where “| |” represents a concatenation and “< . . . >” means place the data on the stack, and “[ . . . ]” is a function comprised by the unlocking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the locking script in the input of Tx₁ contains the signature of Alice signing the expected portion of data. The expected portion of data itself (the “message”) also needs to be included in Tx₀ order to perform this authentication. In embodiments the signed data comprises the whole of Tx₀ (so a separate element does to need to be included specifying the signed portion of data in the clear, as it is already inherently present).

The details of authentication by public-private cryptography will be familiar to a person skilled in the art. Basically, if Alice has signed a message by encrypting it with her private key, then given Alice's public key and the message in the clear (the unencrypted message), another entity such as a node 104 is able to authenticate that the encrypted version of the message must have been signed by Alice. Signing typically comprises hashing the message, signing the hash, and tagging this onto the clear version of the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the node 104 deems Tx₁ valid. If it is a mining node 104M, this means it will add it to the pool of transactions 154 awaiting proof-of-work. If it is a forwarding node 104F, it will forward the transaction Tx₁ to one or more other nodes 104 in the network 106, so that it will be propagated throughout the network. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the node 104 also needs to check whether the referenced UTXO in the preceding transaction Tx₀ is already spent (has already formed a valid input to another valid transaction). This is one reason why it is important for the blockchain 150 to impose a defined order on the transactions 152. In practice a given node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor mined into blocks 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the winning miner, because nowadays the reward of the generation transaction alone is not typically sufficient to motivate mining. If Alice does not include a fee for the miner, Tx₀ will likely be rejected by the miner nodes 104M, and hence although technically valid, it will still not be propagated and included in the blockchain 150 (the miner protocol does not force miners 104M to accept transactions 152 if they don't want). In some protocols, the mining fee does not require its own separate output 203 (i.e. does not need a separate UTXO). Instead any different between the total amount pointed to by the input(s) 202 and the total amount of specified in the output(s) 203 of a given transaction 152 is automatically given to the winning miner 104. E.g. say a pointer to UTXO₀ is the only input to Tx₁, and Tx₁ has only one output UTXO₁. If the amount of the digital asset specified in UTXO₀ is greater than the amount specified in UTXO₁, then the difference automatically goes to the winning miner 104M. Alternatively or additionally however, it is not necessarily excluded that a miner fee could be specified explicitly in its own one of the UTXOs 203 of the transaction 152.

Alice and Bob's digital assets consist of the unspent UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the storage nodes 104S, e.g. the storage node 104S that is closest or best connected to the respective party's computer equipment 102.

Note that the script code is often represented schematically (i.e. not the exact language). For example, one may write [Checksig P_{A}] to mean [Checksig P_{A}]=OP_DUP OP_HASH160<H(P_{A})> OP_EQUALVERIFY OP_CHECKSIG. “OP_ . . . ” refers to a particular opcode of the Script language. OP_CHECKSIG (also called “Checksig”) is a Script opcode that takes two inputs (signature and public key) and verifies the signature's validity using the Elliptic Curve Digital Signature Algorithm (ECDSA). At runtime, any occurrences of signature (‘sig’) are removed from the script but additional requirements, such as a hash puzzle, remain in the transaction verified by the ‘sig’ input. As another example, OP_RETURN is an opcode of the Script language for creating an unspendable output of a transaction that can store metadata within the transaction, and thereby record the metadata immutably in the blockchain 150. E.g. the metadata could comprise a document which it is desired to store in the blockchain.

The signature P_{A} is a digital signature. In embodiments this is based on the ECDSA using the elliptic curve secp256k1. A digital signature signs a particular piece of data. In embodiments, for a given transaction the signature will sign part of the transaction input, and all or part of the transaction output. The particular parts of the outputs it signs depends on the SIGHASH flag. The SIGHASH flag is a 4-byte code included at the end of a signature to select which outputs are signed (and thus fixed at the time of signing).

The locking script is sometimes called “scriptPubKey” referring to the fact that it comprises the public key of the party to whom the respective transaction is locked. The unlocking script is sometimes called “scriptSig” referring to the fact that it supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 2. Hash Trees

The concept of hash trees as a data structure was introduced by Ralph Merkle in 1979. Hash trees have since been used extensively in applications including as a representation of a set of transactions in a block of a blockchain and as a record of state change in versioning systems such as Git version control.

The terms “hash tree” and “Merkle tree” are generally used to refer to the same type of data structure. Where it is considered helpful to draw a distinction between the underlying data structure and a chosen mathematical formulation, the following description may use the term hash tree to refer to the underlying data structure and the term Merkle tree to refer to a hash tree in combination with an indexing scheme for indexing nodes of the hash tree and a set of node equations for constructing the hash tree according to that indexing system.

Merkle trees are generally treated as binary tree data structures comprising nodes and edges. The nodes are represented as hash digests (hash values) and edges are created by application of a one-way function (commonly cryptographic hash functions) to a pair of concatenated nodes, generating a parent. This process is repeated recursively until a single root hash value (root node) is reached.

Merkle trees have been implemented as binary, trinary or more generally k-ary, where k is a common branching factor used throughout the tree. The fact that the branching factor is indeed consistent throughout a Merkle tree is a widely-accepted feature of such trees. Another common feature is that data blocks are only inserted at the bottom layer of the tree (i.e. the layer furthest from the root). A data structure having these constraints may be referred to herein as a “classical” hash (or Merkle) tree.

However, the present disclosure recognized applications in which it is advantageous to have greater flexibility in the construction of Merkle tree than is possible with these common features. Accordingly, a highly generalised treatment of Merkle trees is provided, resulting in a protocol for constructing and manipulating what are referred to herein as “generalised” hash trees. These generalised structures inherit many of the properties of classical Merkle trees, while gaining additional flexibility by removing both the constraints of having a consistent branching factor and of only inserting leaf nodes at the base layer.

The term “schema” may be used herein to refer to the set of constraints imposed on a data structure. For a classical hash tree, those constraints are summarized above and set out in more detail below.

This disclosure provides a novel schema for constructing generalised hash trees, the detail of which are described below.

This disclosure also provides a novel indexing scheme for assigning indexes to nodes of a generalised hash tree. A hash tree indexed according to this indexing scheme may be referred to as a generalised Merkle tree.

Embodiments of the present disclosure are described in detail below. First, there follows a more in-depth description of classical hash trees as context to the described embodiments.

2.1 Classical Hash Trees

A common method for representing large quantities of data in an efficient and less resource-intensive way is to store it in structure known as a hash tree, where a hash is taken to mean the digest of a one-way cryptographic hashing function such as SHA-256.

A typical hash function takes an input of arbitrary size and produces an integer in a fixed range. For example, the SHA-256 hash function gives a 256-bit number as its output hash digest (hash value).

In general, a hash tree is a tree-like data structure comprising “internal” nodes and “leaf” nodes connected by a set of directional edges. Each leaf node represents the cryptographic hash of a portion of data (data block) that is to be “stored” in the tree, and each node is generated by hashing the concatenation of its “children” (child nodes). A child node of a “parent” node is any node directly connected to the parent node by a directional edge. The root node of the hash tree can be used to represent a large set of data compactly, and it can be used to prove that any one of the portions of data corresponding to a leaf node is indeed part of the set. The root node is a single node to which all other nodes are connected either directly or indirectly.

In accordance with terminology used in the art, this disclosure may refer to data being “stored” in the hash tree. However, it will be appreciated that the data is not recoverable from the hash tree itself because of the one-way properties of hash functions (in fact, this is one of the benefits of a hash tree). Rather, the hash tree can be used to verify a data block in the manner described below. Accordingly, where this disclosure refers to data being stored or contained in a hash tree and the like, it will be appreciated that means that the data is represented in the hash tree in the manner set out below, and does not imply that the data is recoverable from the hash tree.

In many applications, binary hash trees are used in which every non-leaf node has exactly two children and leaf nodes are the hash of a block of data. For instance, the bitcoin blockchain uses a binary hash tree implementation to store all the transactions for a block compactly. The root hash is stored in the block header to represent the full set transactions included in a block.

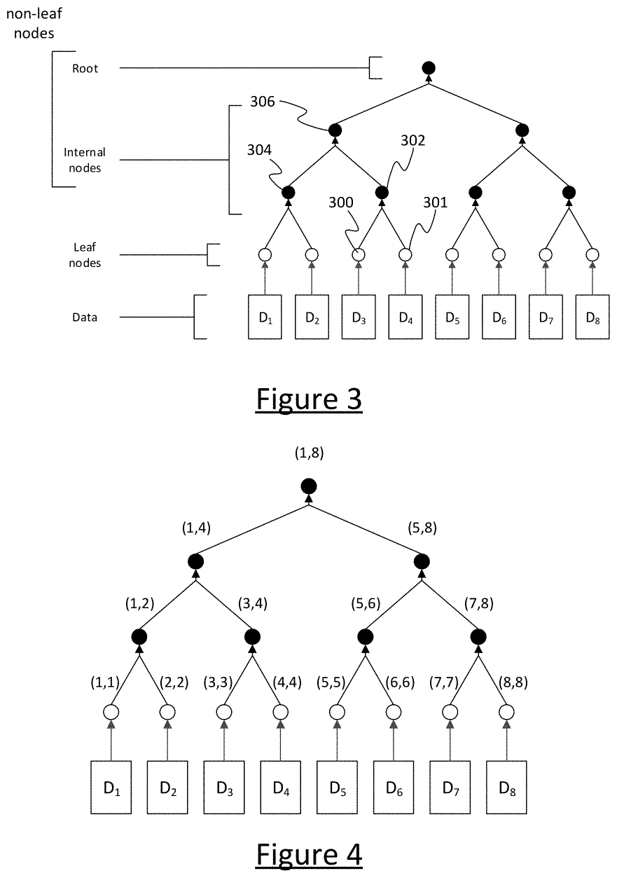

FIG. 3 shows a simple binary hash-tree, in which leaf nodes are represented as white circles and non-leaf nodes are represented as black circles, and edges are represented as line segments between pairs of nodes. Each node is embodied as a hash value computed as set out below.

The structure of a binary hash tree is shown in FIG. 3, where arrows represent the application of a hash function, white circles represent leaf nodes and black circles are used both for internal nodes and the root.

This hash tree stores a set of eight portions of data D₁ . . . D₈ by hashing each portion and concatenating the resulting digests pairwise H(D₁)∥H(D₂), . . . , H(D₇) II H(D₈), where the ‘∥’ operator denotes the concatenation of two strings of data. The concatenated results are then hashed, and the process repeated until there is a single 256-bit hash digest remaining—the Merkle root—as a representation of the entire data set.

By way of example, the nodes denoted by reference numerals 300 and 301 are leaf nodes representing data blocks D₃ and D₄ respectively. Hence, the hash values of the nodes 301 and 302 are H(D₃) and H(D₄) respectively. The nodes 300 and 301 are said to be “sibling nodes” because they have a common parent node denoted by reference numeral 302. The hash value of the parent node 302 is H(H(D₃)\\H (D₄)). In turn, the node 302 is shown to be a sibling node of the node denoted by reference numeral 304 because those nodes have a common parent node 306, which in turn has a hash value equal to the hash of a concatenation of the hash values of its child nodes 302, 304 etc.

2.2 Merkle Trees

The Merkle tree is the original implementation of a hash tree, proposed by Ralph Merkle in 1979; see R. C. Merkle, Stanford University, (1979), Secrecy, Authentication, and Public Key Systems (Merkle's thesis).

A Merkle tree is typically interpreted as a binary hash tree.

In a Merkle tree, each node in the tree has been given an index pair (i,j) and is represented as N(i,j). The indices i,j are simply numerical labels that are related to a specific position in the tree.

An important feature of the Merkle tree is that the construction of each of its nodes is governed by the following equations'

$$N ( i , j ) = \{ \begin{matrix}H ( {D}_{i} ) & i = j \\ H ( N ( i , k ) \vert \vert N ( k + 1 , j ) ) & i \neq j\end{matrix} ,$$

where k=(i+j−1)/2 and H is a cryptographic hash function.

A binary Merkle tree constructed according to these equations is shown in FIG. 4. It can be seen that the i=j case corresponds to a leaf node, which is simply the hash of the corresponding i^{th} block of data Dᵢ. The i #j case corresponds to an internal or root node, which is generated by recursively hashing and concatenating child nodes in the tree until the specific node or the root is reached.

For example, the node N(1,4) is constructed from the four data blocks D₁, . . . , D₄ as

$$N ( 1 , 4 ) = H ( N ( 1 , 2 ) \vert \vert N ( 3 , 4 ) )$$

$$= H [ H ( N ( 1 , 1 ) \vert \vert N ( 2 , 2 ) ) \vert \vert H ( N ( 3 , 3 ) \vert \vert N ( 4 , 4 ) ) ]$$

$$= H [ H ( H ( {D}_{1} ) \vert \vert H ( {D}_{2} ) ) \vert \vert H ( H ( {D}_{3} ) \vert \vert H ( {D}_{4} ) ) ] .$$

¹ These equations have been adapted from Merkle's thesis and simplified.

Each node has a level (depth) in the tree, which corresponds to the number of directional edges via which that node is connected to the common root node, i.e. node (1,8) in the example of FIG. 4 (the level of the root node itself being zero).

The tree has a depth M defined as the lowest level of nodes in the tree, and the depth m of a node is the level at which the node exists. For example, mᵣₒₒₜ=0 and m_{leaf}=M, where M=3 in FIG. 4.

Although a binary tree is shown by way of example, it possible to construct a ternary, quaternary or K-ary Merkle tree, where K is the order of branching of the tree, also referred to as the branching factor.

In general, the core properties and paradigms common to all Merkle tree implementations can be summarised by the following:
1. Common branching order K—the branching order of all non-leaf nodes is common. For a binary Merkle tree, all internal nodes and the Merkle root have exactly two children.
2. Position of leaf nodes—all leaf nodes are situated uniformly at the bottom of the tree. This means that data blocks can only be injected into the tree at the same base layer.

These properties are an artefact of the Merkle tree having been designed to store a list of data blocks in an optimally-efficient manner. However, while this design lends itself extremely well to cryptographic signature schemes and storing of blockchain transactions for example, it is subject to constraints that make it sub-optimal for other applications.

A consequence of property 1 is that, to store N data blocks in a Merkle tree with branching factor K, the tree must have K^{M}≥N leaf nodes. This is beneficial in that the depth of the tree grows logarithmically in the total storage requirement. However, this also means that in all the cases where K^{M}>N the Merkle tree must be “padded” with an additional N′=K^{M}−N leaf nodes containing null data. This means that a Merkle tree will often contain extraneous data that is not of interest to the user of the tree.

Additionally, property 2 means that it is not possible to add or inject data blocks at any level of the tree other than at its base. This makes it very difficult to reflect a hierarchy or structure relating to a data set within the Merkle tree itself.

### Merkle Proofs

The primary function of a Merkle tree in most applications is to facilitate a proof that some data block Dᵢ is a member of a list or set of N data blocks [symbol] ε{D₁, . . . , D_{N}}. Given a Merkle root and a candidate data block Dᵢ, this can be treated as a ‘proof-of-existence’ of the block within the set.

The mechanism for such a proof is known as a Merkle proof and consists of obtaining a set of hashes known as the “Merkle path” for a given data block Dᵢ and Merkle root R. The Merkle path for a data block is simply the minimum list of hashes required to reconstruct the root R by way of repeated hashing and concatenation, and may also be referred to as the “authentication path” for a data block.

### Method

If, given a Merkle root R and given data block D₁ to be “verified”—verified in this context means proving that the data block D₁ belongs to the set [symbol] ε{D₁, . . . , D_{N}} represented by R (i.e. the set of data blocks from which the hash tree is constructed)—the data block D₁ is verified as follows. The data block D₁ is considered by way of example by the proof can be performed for any given data block to determine whether or not it corresponds to one of the data blocks used to construct the hash tree.

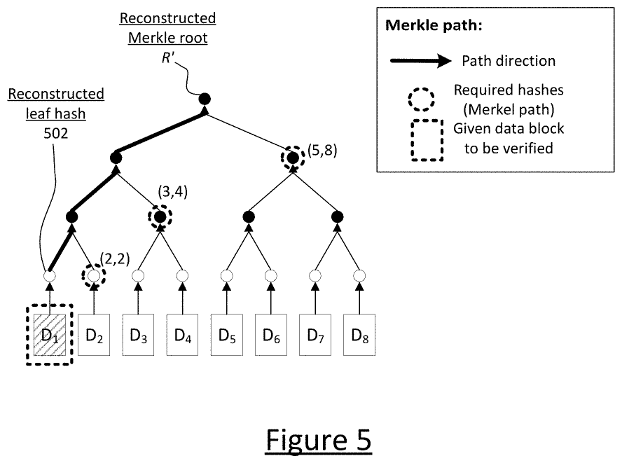

With reference to FIG. 5, to verify the data block D₁, a Merkle proof is performed as follows:
i. Obtain the Merkle root R from a trusted source.
ii. Obtain the Merkle path F from a source. In this case, F is the set of hashes:

Γ={N(2,2),N(3,4),N(5,8)}.
iii. Compute a Merkle proof using D₁ and F as follows:
   a. Hash the data block to obtain:
      N(1,1)=H(D₁) (the “reconstructed leaf hash” 502).
   b. Concatenate with N(2,2) and hash to obtain:

N(1,2)=H(N(1,1)∥N(2,2)).
c. Concatenate with N(3,4) and hash to obtain:

N(1,4)=H(N(1,2)∥N(3,4)).
d. Concatenate with N(5,8) and hash to reconstruct the root:

N(1,8)=H(N(1,4)∥N(5,8)),
R′=N(1,8) (the “reconstructed root hash”).
e. Compare the calculated root R′ with the root R obtained in (i):
I. If R′=R, the existence of D₁ in the tree, and therefore the data set
   [symbol] , is confirmed.
II. If R′ #R, the proof has failed and D₁ is not confirmed to be a member of [symbol] .

This is an efficient mechanism for providing a proof-of-existence for some data as part of the data set represented by a Merkle tree and its root. For example, if the data D₁ corresponded to a blockchain transaction and the root R is publicly available as part of a block header then it is possible to quickly prove that the transaction was included in that block.

The process of authenticating the existence of D₁ as part of the example Merkle tree is shown in FIG. 5. This demonstrates that performing the Merkle proof for a given block D₁ and root R is effectively traversing the Merkle tree ‘upwards’ by using only the minimum number of hash values necessary.

2.1.2 Tree Structures in Graph Theory

A hash tree or Merkle tree may be interpreted in the context of graph theory. A hash tree comprises vertices or nodes of data—hash values—and edges connecting nodes formed by the hashing of multiple concatenated vertices.

More specifically, in graph theory a hash tree is considered to have the following key properties

Directed—the edges between nodes are formed by computing a one-way hash function which can only be performed in one-direction. This means that every edge in the hash tree has a direction, and therefore the tree is

Acyclic—there are no cyclical paths in the structure of a hash tree.

Graph—a hash tree can be classified as a graph because it comprises vertices and edges that connect its vertices.

The combination of all three of these properties means that a hash tree or Merkle tree satisfies the definition of a directed acyclic graph (DAG).

A directed graph is termed weakly connected if the replacement of its directed edges with undirected edges forms a connected graph. A hash tree satisfies this criterion, so it is also a weakly connected DAG.

A “rooted tree” is defined as a tree in which one vertex or node is identified as the root of the tree, and if the rooted tree also has an underlying directed graph then it is termed a directed rooted tree. Moreover, in a directed rooted tree, all the edges are either directed away from (arborescent) or towards (anti-arborescent) the designated root.

This disclosure recognizes a hash tree or Merkle tree to be an example of the latter—i.e., an anti-arborescent directed rooted tree—whereby all of its edges are constructed by hashing vertices ‘towards’ the root.

### 3. Generalised Hash Tree Protocol

The described embodiments provide a generalised hash tree data structure explicitly defined to have the following properties:

Hierarchical position of leaf nodes—leaf nodes can be placed at any level of the tree below the root hash. This allows data to be injected into different levels of the hash tree that reflects an external hierarchy of the data.

Arbitrary number of children—each node may have an arbitrary number of children (or ‘in-degree’), which may comprise any number of internal child nodes and any number of leaf child nodes.

Variable branching factor—the branching factor K for an internal node, giving the ratio of the number of children (in-degree) to number of parents (out-degree), does not have to be common throughout the tree.

These properties in combination allow the construction of a hash tree that can represent a data set with a second-tier hierarchy overlaid on top of it, whilst also maintaining the core function of the tree, namely the ability to efficiently verify a given data block using the same Merkle proof principles as set out above.

These core functions are that the tree must be able to represent the entire data set in a single hash value, i.e. the root (i.e. all nodes must be directly or indirectly connected to a common root node) and that it must be possible to perform a Merkle proof of existence on any one block of data in the set, irrespective of its position in the hierarchy.

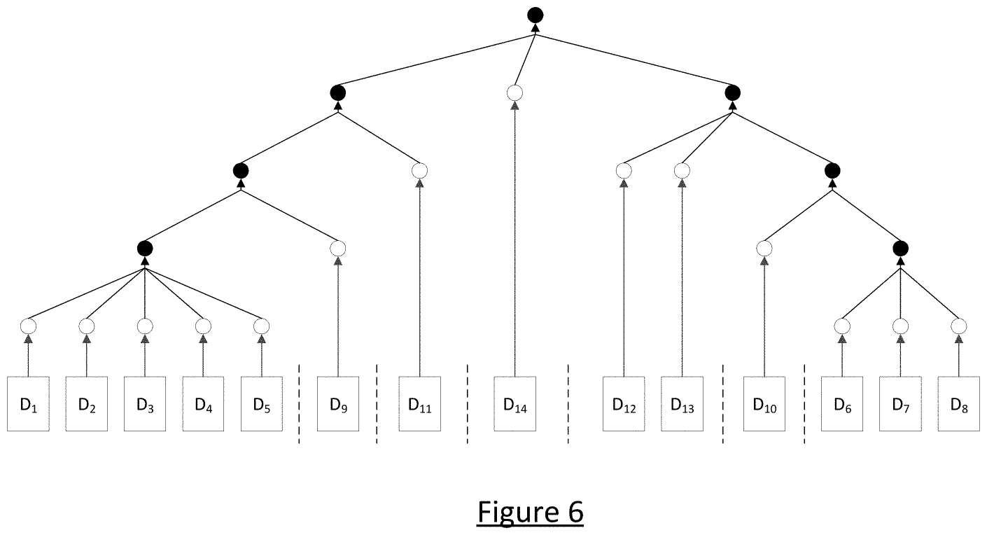

An example of a generalised hash tree structure is shown in FIG. 6. This example demonstrates a hierarchy of fourteen data blocks D₁-D₁₄, which are injected into the hash tree at varying levels. This is in contrast to a traditional Merkle tree structure, in which all of these injections of data would happen at the bottom layer of the tree.

Rules of the Generalised Hash Tree

A hash tree which achieves the desired properties can be constructed according the following set of rules. Using the above terminology, this set of rules constitutes the “schema” according to which any generalised hash tree is constructed:
1. Nodes—a node can have at most one parent and an arbitrary number of children. Nodes are generally either leaf nodes or non-leaf nodes, but overall can be diversified into three categories:
   a. A root node is defined by having no parent.
   b. An intermediary node is defined by having at least one parent and at least one child.
   c. A leaf node is defined by having no children.
Note that both (a) and (b) are examples of non-leaf nodes, while (c) are leaf nodes.
2. Edges—An edge is created by hashing a node concatenated with its siblings in a specific order. The edge between a parent and child is created by hashing of all the parent's children concatenated in sequence.
Given a parent P and four children, C₁, C₂, C₃, C₄, the following edges can be created:
   C₁→) P: H(C₁∥C₂∥C₃∥C₄)
   C₂→) P: H(C₁∥C₂∥C₃∥C₄)
   C₃→) P: H(C₁∥C₂∥C₃∥C₄)
   C₄→) P: H(C₁∥C₂∥C₃∥C₄)
Note that the mathematical construction of each edge is the same, and therefore an edge between parent and child may only be created once the entire set of siblings is known.
Note also that the resulting hash value H(C₁∥C₂∥C₃∥C₄) is the hash value of the parent node. Therefore, Rule 2 can be equivalently formulated as “the hash value of the parent node is a hash of a concatenation of the hash values of its child nodes” in a specified order.
3. Arbitrary number of children—there is no restriction on the number of children any non-leaf node may have. Leaf nodes have no children by definition (see rule 1).
4. Position of leaf nodes—there is no restriction on the depth at which a leaf node may be placed in the hash tree. A leaf node may therefore exist at any level in the tree.

In order to provide additional robustness against “second pre-image attacks”, an additional rule may also be introduced into the schema:
5. Leaf and non-leaf nodes are distinguishable—all leaf nodes may be explicitly distinguishable from non-leaf nodes. This may for example be done by prepending the hash value of each leaf node with a predetermined prefix e.g. 0x00.

A second pre-image attack refers to a situation in which an attacker successfully discovers preimage of a hash value (i.e. a data block which hashes to that value) without knowledge of the original preimage for which the hash value was computed.

Applying the above terminology, a generalised Merkle tree has additional rules relating to indexing and node equations, which may be formalized as follows:
6. Indexing system—all nodes must be labelled uniquely and according to a common indexing system (see 3.1.1).
7. The Golden Rule—when labelling a set of sibling nodes, the non-leaf siblings are labelled before the leaf siblings (see 3.1.2).
8. Node equations—all nodes must obey the node equation for the generalised hash tree. This equation relies on the structure provided by an indexing system and allows the hash value of every node in the tree to be constructed in a recursive manner from its children (see 3.3).

Note: Rules 5 to 8 are optional in respect of generalised hash trees. That is to say, only Rules 1 to 4 define fundamental properties of a generalised hash trees. Rule 5 is an optional implementation feature to provide additional security, and Rules 6 to 8 define a particularly convenient set of node equations for constructing a generalised hash tree and an indexing scheme adopted in those node equations (noting that, although convenient, other indexing schemes and node equation formulations may nonetheless be viable).

3.1.1 Indexing System

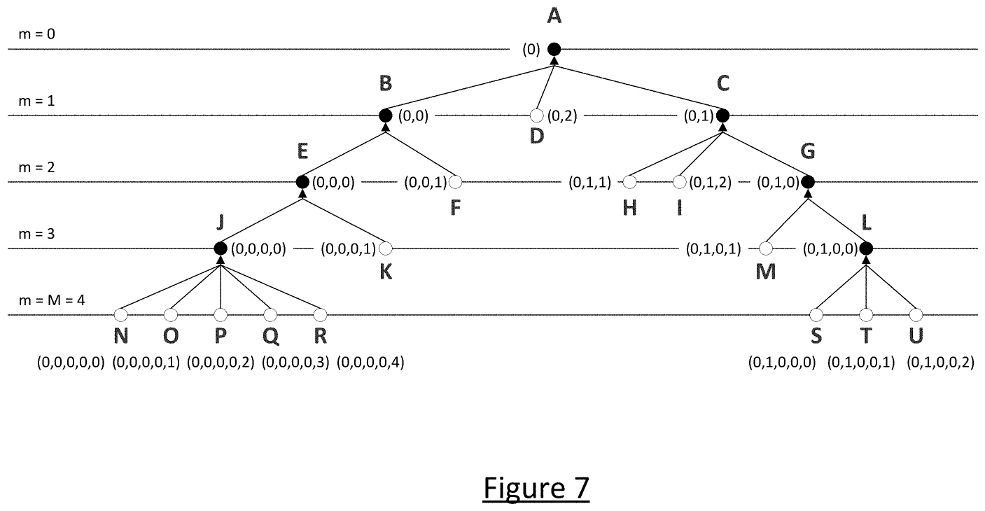

FIG. 7 shows the generalised hash tree of FIG. 6 with all nodes given an alphabetical reference sign A-U.

In order to create a generalised hash tree such as the example shown in FIG. 5 (see 3.2), the above-mentioned indexing and notation system allows each node to be identified easily and betrays its position within the hash tree clearly.

The basic notation used to represent a node in the generalised hash tree is

Node: N_{0,i}_{_{0, . . . ,}}ᵢ_{_{m−2,}}ⱼ.

The term “index tuple” may be referred to the indexes (0, i₀, . . . , iₘ₋₂,j) of the node N_{0,i}_{_{0, . . . ,}}ᵢ_{_{m−2,}}ⱼ, noting that these indexes have a defined order. The level of the node in the tree is encoded in terms the number of indexes of its index tuple: a node with an index tuple containing m+1 indexes is at level m. This description adopts the convention that the root hash is at level m=0 and the deepest leaf node is at level m=M, where M is termed the depth of the tree, and with this definition

The sub-script indices trace a path down the tree from the root node to the node in question. This path can be broken down into three types of sub-script indices

Root index—the null index ‘0’ is always the first sub-script index, signifying that each node in the tree is connected by a finite number of edges to the root. The root node is labelled N₀.

Intermediary index—a node at level m will always have m−2 intermediary indices (null if m≤2). These indices represent the path of nodes from the root to the parent of the node in question. These indices are written as i₀, . . . , iₘ₋₂.

Sibling index—the final sub-script index j of a node indicates its position with respect to its siblings.

Each node in a generalised hash tree will have exactly m+1 indices: one root index (0), m−2 intermediary indices (i₀, . . . , iₘ₋₂) and one sibling index (j).

Note also that all indices are non-negative integers, starting from zero and increasing.

For ease of explanation, an internal node may be referred to as an ‘intermediary node’ when discussing blockchain-based implementations of the generalised hash tree method. Henceforth, these two terms will be considered equivalent and interchangeable.

Note that the root index need not be explicitly encoded when indexes are computed, because it is always zero (i.e. the root index may be implicit in that it is not actually stored as a value when the index tuples are computed).

The Golden Rule

Indexes are assigned in accordance with the above indexing system according to a golden rule (GR). The rule is stated as follows:

GR—when determining the sibling indices j for n sibling nodes, values j=0, . . . , j=n−1 are assigned:
1. From left to right; and
2. Such that intermediary siblings are assigned before leaf siblings.

Nodes are named top-to-bottom and left-to-right. Top-to-bottom locates the branching path and hence the parent of a node. The right-to-left indicates the position of a child of said parent relative to its siblings.

Hashing

As will be shown in the node equations, the process of hashing has two meanings in the generalised hash tree. Any data block D that is to be included in the tree, at any level, will be double-hashed as H²(D) to form a leaf node (the value of which is a “double-hash” value). However, whenever multiple leaf and/or internal nodes are combined to form a new internal node in the tree, they are concatenated and hashed only once i.e. H(Leaf₁∥Leaf₂) (to obtain a “single-hash” value).

Double hashing provides the benefit that a single-hash value (i.e. as obtained by applying the hash function only once to the data block—referred to single-hashing) can be published to provide proof of ownership or receipt of the underlying data block, which in turn can be verified in respect of the generalised hash tree, without revealing the data block itself. This is beneficial when the hash tree is used to represent sensitive data. More generally, the term “multi-hash” refers to a hash value obtained by hashing a data block two or more times (i.e. hashing the data block and then, at the very least, hashing the result thereof using the same or a different hash function).

Alternatively, for non-sensitive data, single-hashing may be sufficient, i.e. the hash value of each leaf node may be a single-hash of the underlying data block.

The generalised hash tree and method are not limited to any single hashing algorithm or function, and simply require that a cryptographically-secure one-way function is used.

Indexing the Generalised Hash Tree

FIG. 7 shows an example of the generalised hash tree structure of FIG. 6, whereby the indexing conventions have been employed. Thus:

The root node—there is only ever one root node in the hash tree, in this case labelled A.

e.g. A is labelled: N₀.

Intermediary nodes—the nodes B, C, E, G, J and L are all intermediary nodes, acting as a summary of the hashes of the sub-tree beneath it.

e.g. B is labelled: N_{0,0}.

e.g. K is labelled: N_{0,0,0,1}.

etc.

Leaf nodes—the nodes D, F, H, I, K, M, N, O, P, Q, R, S, T and U are all leaf nodes, comprising the double hash of a data block.

e.g. F is labelled: N_{0,0,1}.

e.g. P is labelled: N_{0,0,0,0,2}.

e.g. U is labelled: N_{0,1,0,0,2}.

etc.

The full list of labels for all the nodes in FIG. 7 are shown in Table 1.

| | | | | | Intermediary | | |
|---|---|---|---|---|---|---|---|
| | | | | | indices, | Sibling | Number of |
| | | Name | Node Indices | Node Label | {i₀, . . . , iₘ₋₂} | index, j | children, n |
| Level of | m = 0 | A | (0) | N₀ | {none} | none | 3 |
| node, m | m = 1 | B | (0, 0) | N_{0, 0} | {none} | 0 | 2 |
| | | C | (0, 1) | N_{0, 1} | {none} | 1 | 3 |
| | | D | (0, 2) | N_{0, 2} | {none} | 2 | 0 |
| | m = 2 | E | (0, 0, 0) | N_{0, 0, 0} | {0} | 0 | 2 |
| | | F | (0, 0, 1) | N_{0, 0, 1} | {0} | 1 | 0 |
| | | G | (0, 1, 0) | N_{0, 1, 0} | {1} | 0 | 2 |
| | | H | (0, 1, 1) | N_{0, 1, 1} | {1} | 1 | 0 |
| | | I | (0, 1, 2) | N_{0, 1, 2} | {1} | 2 | 0 |
| | m = 3 | J | (0, 0, 0, 0) | N_{0, 0, 0, 0} | {0, 0} | 0 | 5 |
| | | K | (0, 0, 0, 1) | N_{0, 0, 0, 1} | {0, 0} | 1 | 0 |
| | | L | (0, 1, 0, 0) | N_{0, 1, 0, 0} | {10} | 0 | 3 |
| | | M | (0, 1, 0, 1) | N_{0, 1, 0, 1} | {1, 0} | 1 | 0 |
| | m = 4 | N | (0, 0, 0, 0, 0) | N_{0, 0, 0, 0, 0} | {0, 0, 0} | 0 | 0 |
| | | O | (0, 0, 0, 0, 1) | N_{0, 0, 0, 0, 1} | {0, 0, 0} | 1 | 0 |
| | | P | (0, 0, 0, 0, 2) | N_{0, 0, 0, 0, 2} | {0, 0, 0} | 2 | 0 |
| | | Q | (0, 0, 0, 0, 3) | N_{0, 0, 0, 0, 3} | {0, 0, 0} | 3 | 0 |
| | | R | (0, 0, 0, 0, 4) | N_{0, 0, 0, 0, 4} | {0, 0, 0} | 4 | 0 |
| | | S | (0, 1, 0, 0, 0) | N_{0, 1, 0, 0, 0} | {1, 0, 0} | 0 | 0 |
| | | T | (0, 1, 0, 0, 1) | N_{0, 1, 0, 0, 1} | {1, 0, 0} | 1 | 0 |
| | | U | (0, 1, 0, 0, 2) | N_{0, 1, 0, 0, 2} | {1, 0, 0} | 2 | 0 |

Table 1: The labels and notations for the hash tree of FIGS. 6 and 7.

This table is a complete representation of the hash tree shown in FIG. 6. Such a table representation may be used to tangibly embody a generated hash tree data structure, for example in an off-chain system (see below).

The Node Equations

Recall the notation for a node N_{0,i}_{_{0, . . . ,}} ᵢ_{_{m−2}}_{,j, which may have any number of children n.}

Throughout this section, the symbol + is used to represent data concatenation (usually denoted II) and the use of angle brackets (denoting the pushing of the data within a pair of angle brackets to the stack) is dropped. That is, x+y is taken to mean ( [symbol] x [symbol] ∥ [symbol] γ [symbol] .

A function G_{α} is defined to compute the concatenative sum over all elements α, or at least elements corresponding to a in the range 0≤α≤n−1, as the following (noting that Σ denotes concatenation, not summation, over the defined range):

G_{α}(x):=Σ_{α}=xₐ=Σ_{α=0}ⁿ⁻¹xₐ=x₀+x₁+ . . . +xₙ₋₁.

In accordance with the generalised hash tree schema, the value of each node can be defined simply as the hash of the concatenative sum of all its children in order (as specified by the golden rule of 3.1.2). This can be written mathematically as

Node:=H(ΣChild₀+Child₁+ . . . +Childₙ₋₁).

This definition for the value of a node can now be expressed using the concatenative summation notation from above, where each element xₐ becomes a respective child of a node, as the following:

$${N}_{0 , {i}_{0} , … , {i}_{m - 2} , j} := H ( {\sum }_{α = 0}^{n - 1} {N}_{0 , {i}_{0} , … , {i}_{m - 2} , j , α} ) ,$$

$$= H ( {N}_{0 , {i}_{0} , … , {i}_{m - 2} , j , 0} + {N}_{0 , {i}_{0} , … , {i}_{m - 2} , j , 1} + … + {N}_{0 , {i}_{0} , … , {i}_{m - 2} , j , n - 1} ) ,$$

which captured the fact that a node is the hash of the concatenation of all its children in order in terms of mathematical operations defined in relation to the above indexing scheme.

The node whose value is being calculated has m+1 indices, therefore its children must necessarily have exactly m+2 indices, whereby the first m+1 indices of the children are identical to those of the parent. Note that the dummy index α, used for summation, therefore represents the additional sibling index (the m+2^{th} index) of each respective child of the node in question.

Recursion

This principle of adding an additional index for each incremental increase in the level of the node allows the value of a node to be expressed using a succinct recursive expression.

Greek letters (α, β, γ, . . . ω) are used to represent the “dummy” (sibling) indices that express this recursion, so as not to confuse with the Latin letters (i,j) used to express the original m+1 indices of the node to be calculated.

To see how this recursion works in the formula above, consider a node N_{0,i}_{_{0, . . . ,}}ᵢ_{_{m−2}}_{,j} which has many descendants spanning many generations. The sibling index of the first generation of descendants is denoted by the dummy index α, the second generation denoted by and so forth down to the final (deepest) generation denoted by co.

The formula for the value of the node can then be written in the following way:

$${N}_{0 , {i}_{0} , … , {i}_{m - 2} , j} := H ( {\sum }_{α = 0}^{n - 1} {N}_{0 , {i}_{0} , … , {i}_{m - 2} , j , α} ) ,$$

$$= H ( {\sum }_{α = 0}^{n - 1} H ( {\sum }_{β = 0}^{{n}^{′} - 1} {N}_{0 , {i}_{0} , … , {i}_{m - 2} , j , α , β} ) ) ,$$

$$= H ( {\sum }_{α = 0}^{n - 1} H ( {\sum }_{β = 0}^{{n}^{′} - 1} H ( {\sum }_{γ = 0}^{{n}^{″} - 1} {N}_{0 , {i}_{0} , … , {i}_{m - 2} , j , α , β , γ} ) ) ) ,$$

$$= H ( {\sum }_{α = 0}^{n - 1} H ( {\sum }_{β = 0}^{{n}^{′} - 1} H ( {\sum }_{γ = 0}^{{n}^{″} - 1} … H ( {\sum }_{ω = 0}^{{n}^{′ … ′} - 1} {N}_{0 , {i}_{0} , … , {i}_{m - 2} , j , α , β , γ , … , ω} ) … ) ) ) .$$

It can be seen that each first descendant of the node in question can be expanded in terms of its “descendants” (children and, where applicable, grandchildren, i.e. nodes indirectly connected to it via one or more other nodes), and these in turn can be expanded in terms of their descendants recursively until the bottom-most generation (denoted by ω) is reached.

Note here that the summation upper limit changes for each descendant generation to reflect the fact that different descendants may have a different number of children.

For instance, the dummy index α ranges from 0≤a≤n−1 to indicate that the node whose value is to be calculated has n children. Each of these children may have a different number of children n′ themselves (second generation w.r.t the node) and so the dummy index runs from 0≤β≤n′−1 to reflect this.

To summarise, the expression for the value of a node can be written in a recursive way that expresses how the value of a node is built up from not only its children but indeed all of its descendants as

N_{0,i}_{_{0, . . . ,}}ᵢ_{_{m−2}}_{,j}:=H(Σ_{α=0}ⁿ⁻¹. . . H(Σ_{ω=0}^{n′ . . . ′-1}N_{0,i}_{_{0 . . .}} _{,i}_{_{m−2}}_{,j,α, . . . ,ω}) . . . ).

Leaf and Non-Leaf Nodes

As outlined in section 3.1, the generalised hash tree may comprise leaf nodes (having no children) and non-leaf children (having at least one child).

These two classes of nodes are fundamentally different. A leaf node represents an ‘end point’, and usually some data D, that terminates a particular tree branch, while a non-leaf node does not terminate a branch and may have many descendant generations.

This difference is reflected in the node equations to ensure that leaf and non-leaf nodes are treated differently.

The value of a leaf node N_{0,i}_{_{0, . . . ,}}ᵢ_{_{m−2}}_{,j, with n=}0 children, is defined as the double-hash of the data packet D_{0,i}_{_{0, . . . ,}}ᵢ_{_{m−2}}_{,j} represented by that node. This is written as

N_{0,i}_{_{0, . . . ,}}ᵢ_{_{m−2}}_{,j}:=H²(D_{0,i}_{_{0, . . . ,}}ᵢ_{_{m−2}}_{,j}),n=0.

The distinction between the value of non-leaf nodes and that of leaf nodes is used when writing the final version of the node equations.

Splitting the Summation

In section 3.1.2, the golden rule (GR) established that, for a given set of sibling nodes, non-leaf nodes are labelled before leaf nodes.

The reason for this was to ensure that the recursive formula for nodes would consistently sum the non-leaf children, which in turn must be expanded into their own children, before the leaf children.

Conceptually, this aspect of the GR allows the formula for the value of a node to be computed by splitting the “summation” (or rather, concatenation) into two “summations” over different limits as follows

$${N}_{0 , {i}_{0} , … , {i}_{m - 2} , j} := H ( {\sum }_{α = 0}^{n - 1} {N}_{0 , {i}_{0} , … , {i}_{m - 2} , j , α} ) ,$$

$$= H ( {\underbrace{{\sum }_{α = 0}^{ϵ - 1} {N}_{0 , {i}_{0} , … , {i}_{m - 2} , j , α}}}_{Sum over non - leaves} + {\underbrace{{\sum }_{α = ϵ}^{n - 1} {N}_{0 , {i}_{0} , … , {i}_{m - 2} , j , α}}}_{Sum over leaves} ) .$$

The above split summation considers a node with a total of n children, split into E non-leaf children and n−∈ leaf children respectively. This, in turn, reflects the fact that, in a generalised hash tree, a parent node can have a mixture of both leaf child node(s) and non-leaf-child node(s), in contrast to a classical has tree.

The limits on the left-hand sum represent the concatenation all of the non-leaf children, which is done here before the right-hand sum concatenates all of the leaf children. This is the intended consequence of the GR as formulated previously.

The Node Equations

In summary, a pair of succinct equations for the value of any given node in the generalised hash tree can be written as:

$${N}_{0 , {i}_{0} , … , {i}_{m - 2} , j} := \{ \begin{matrix}{H}^{2} ( {D}_{0 , {i}_{0} , … , {i}_{m - 2} , j} ) & n = 0 \\ H ( {\sum }_{α = 0}^{n - 1} {N}_{0 , {i}_{0} , … , {i}_{m - 2} , j , α} ) & n > 0\end{matrix}$$

These equations account for the distinctions between leaf nodes and non-leaf nodes, express the value of a node recursively as the culmination of its descendants and can be separated at any level into non-leaf and leaf children.

These equations can also be rewritten using the concatenative summation function Gₐ as:

$${N}_{0 , {i}_{0} , … , {i}_{m - 2} , j} := \{ \begin{matrix}{H}^{2} ( {D}_{0 , {i}_{0} , … , {i}_{m - 2} , j} ) & n = 0 \\ H ( {G}_{α} ( {N}_{0 , {i}_{0} , … , {i}_{m - 2} , j} ) ) & n > 0\end{matrix}$$

Calculating Node Hash Values

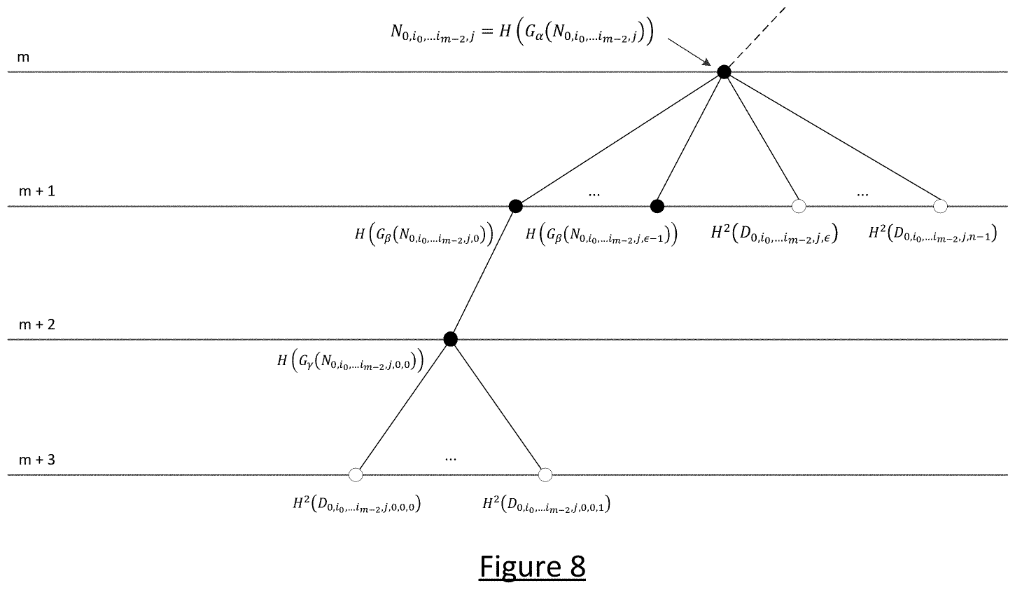

FIG. 8 shows a branch of a generalised hash tree, showing how a node (level m) is calculated from its descendants.

An example node N_{0,i}_{_{0, . . . ,}}ᵢ_{_{m−2}}_{,j} is shown whose value is to be calculated. The node is at an arbitrary level m and may have multiple “ancestors” above it (denoted by the dotted line; ancestors being nodes to which it is directly or indirectly connected), however only its descendants need to be considered in order to calculate its hash value.

Black circles are used to represent non-leaf nodes and white circles are used to represent leaf nodes.

The value the node is calculated, using the recursive node equations, in a few steps as shown below.

1. Write the node in terms of a concatenative sum:

N_{0,i}_{_{0, . . . ,}}ᵢ_{_{m−2}}_{,j}=H(G_{α}(N_{0,i}_{_{0, . . . ,}}ᵢ_{_{m−2}}_{,j})).

2. Expand the sum in terms of then children of that node. In the diagram these are shown split into E non-leaf nodes and n−∈ leaf nodes:

$${G}_{α} ( {N}_{0 , {i}_{0} , … {i}_{m - 2} , j} ) = {\underbrace{H ( {G}_{β} ( {N}_{0 , {i}_{0} , … {i}_{m - 2} , j , 0} ) ) + … + H ( {G}_{β} ( {N}_{0 , {i}_{0} , … {i}_{m - 2} , j , ϵ - 1} ) )}}_{Non - leaf children} + {\underbrace{{H}^{2} ( {D}_{0 , {i}_{0} , … {i}_{m - 2} , j , ϵ} ) + … + {H}^{2} ( {D}_{0 , {i}_{0} , … {i}_{m - 2} , j , n - 1} )}}_{Leaf children} .$$

3. Expand the non-leaf children again in terms of their own children. In this case, although

N_{0,i}_{_{0, . . . ,}}ᵢ_{_{m−2}}_{,j, ∈-1} is a non-leaf and has descendants, only the expansion of the node N_{0,i}_{_{0, . . . ,}}ᵢ_{_{m−2}}_{,j,0} is shown for simplicity:

G_{β}(N_{0,i}_{_{0, . . .}} ᵢ_{_{m−2}}_{,j,0})=H(G_{γ}(NN_{0,i}_{_{0, . . . ,}}ᵢ_{_{m−2}}_{,j,0,0})).

4. Expand the final non-leaf descendant in terms of its own children. This leaves two leaf node children, so all branches underneath N_{0,i}_{_{0, . . . ,}}ᵢ_{_{m−2}}_{,j} have now terminated:

G_{γ}=N_{0,i}_{_{0, . . . ,}}ᵢ_{_{m−2}}_{,j,0,0}=H²(D_{0,i}_{_{0, . . . ,}}ᵢ_{_{m−2}}_{,j,0,0,0})+H²(D_{0,i}_{_{0, . . . ,}}ᵢ_{_{m−2}}_{,j,0,0,1})

5. Plug in all of the required hash values, from the bottom upwards, in order to calculate the node hash value using the equation from step 1:

$${N}_{0 , {i}_{0} , … {i}_{m - 2} , j} = H ( {G}_{α} ( {N}_{0 , {i}_{0} , … {i}_{m - 2} , j} ) ) = H ( H ( {G}_{β} ( {N}_{0 , {i}_{0} , … {i}_{m - 2} , j , 0} ) ) + … + H ( {G}_{β} ( {N}_{0 , {i}_{0} , … {i}_{m - 2} , j , ϵ - 1} ) ) + {H}^{2} ( {D}_{0 , {i}_{0} , … {i}_{m - 2} , j , ϵ} ) + … + {H}^{2} ( {D}_{0 , {i}_{0} , … , {i}_{m - 2} , j , n - 1} ) ) = H ( H ( H ( {G}_{γ} ( {N}_{0 , {i}_{0} , … {i}_{m - 2} , j , 0 , 0} ) ) ) + … + {H}^{2} ( {D}_{0 , {i}_{0} , … {i}_{m - 2} , j , n - 1} ) ) = H ( H ( H ( {H}^{2} ( {D}_{0 , {i}_{0} , … {i}_{m - 2} , j , 0 , 0 , 0} ) + {H}^{2} ( {D}_{0 , {i}_{0} , … {i}_{m - 2} , j , 0 , 0 , 1} ) ) ) + … + {H}^{2} ( {D}_{0 , {i}_{0} , … {i}_{m - 2} , j , n - 1} ) ) .$$

Note how the final line of the calculation is entirely in terms of leaf node hash values, which are dependant only on the data packets D corresponding to these leaf nodes.

Extending a Generalised Hash Tree

A key advantageous property of the generalised hash tree is that it is possible to add new data to the tree at any time after its initial creation.

For example, if a generalised hash tree is used to represent a stable version of a document at one point in time, it is simple to make an additional change at some later time by adding a new data leaf H²(D_{new}) at any point in the tree.

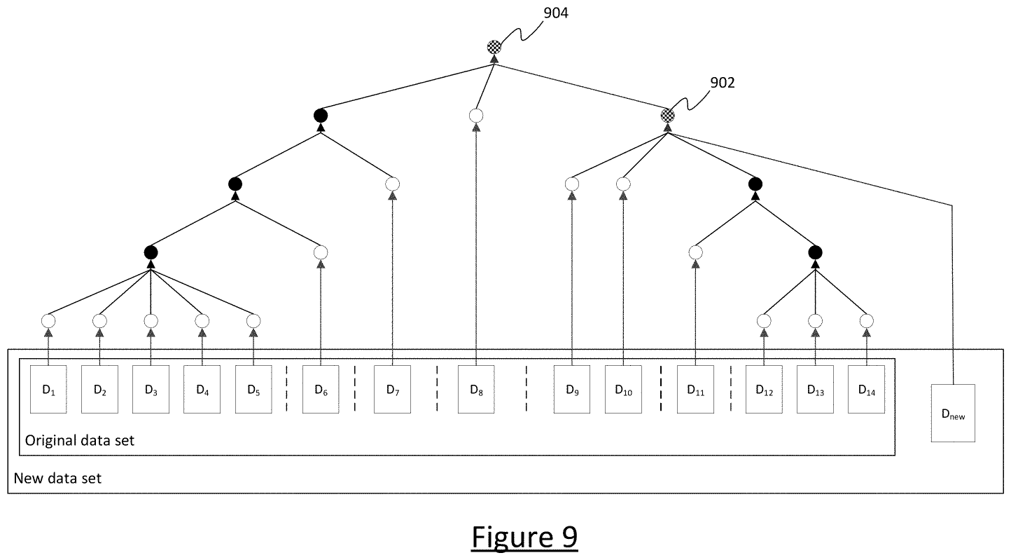

By way of example, FIG. 9 shows a generalised hash tree that is extended by an additional data packet D_{new}. The nodes of the original tree that need to be updated are shown as chequered circles denoted by reference numerals 902 and 904 respectively, node 904 being the root node.

Depending on where and at which level in the tree the new data is inserted, certain nodes will have to be recalculated as their unique hash values will have changed. This allows a change to propagate from any position in the tree upwards and reflect a hierarchy of change after-the-fact.

For the avoidance of doubt, in a blockchain context, references to changing or modifying a hash tree that has been committed to the blockchain do not imply any modification of immutably recorded data within the blockchain. Rather, for example, set of rules can be constructed for interpreting different versions of a hash tree stored in the blockchain (e.g. a simple rule might be that the latest version is interpreted as overwriting an earlier version of a portion thereof). For example, one could write new transactions to the blockchain to extend the hash tree in this way and interpret the latest ‘version’ of the data according to its recency as it appeared on the blockchain. Versioning can be resolved between blocks (i.e. which transaction was in the most recent block mined) and also within a block (i.e. which transaction appeared ‘highest’/‘lowest’ in a given block, if they are in the same block). Computing Merkle proofs of existence

An important benefit of the generalised hash tree is that a proof of existence can still be computed with a level of efficiency comparable to a classical Merkle tree, using a Merkle tree proof (see 2.1.1).

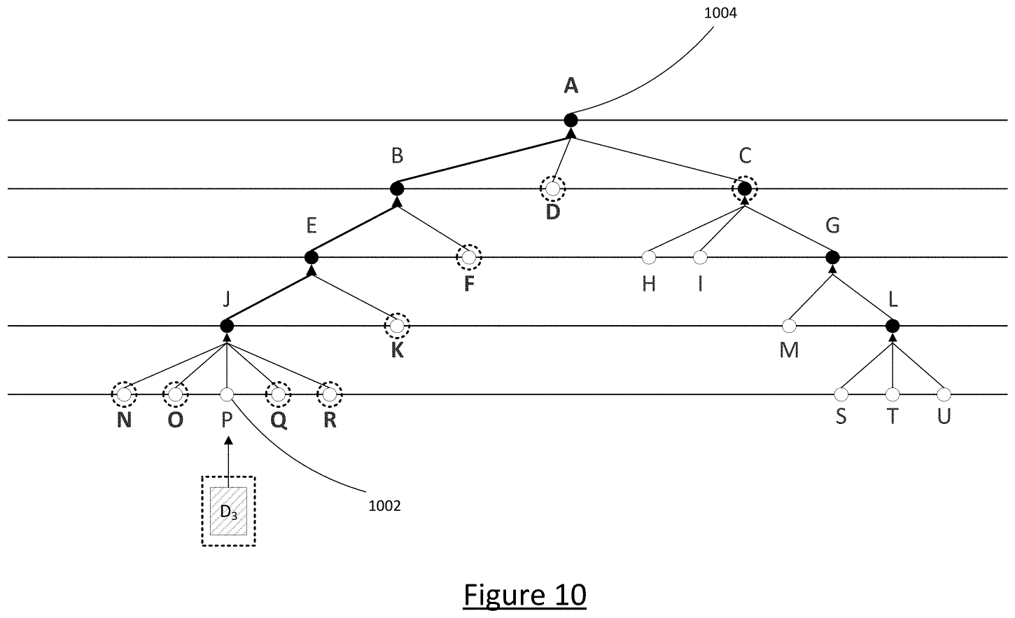

FIG. 10 shows schematically how a Merkle proof performed on a given (arbitrary) data block D₃. As in FIG. 5, nodes belonging to the authentication path for that data block are surrounded by dotted circles.

A reconstructed root hash 1004 is computed by (in this case) double-hashing the data block D₃ to be verified (comparable to the root hash 502 of FIG. 5), and a reconstructed root hash 1004 is computed by applying successive concatenation and hashing operations to the reconstructed root hash 1002 and the hash values of the nodes of the authentication paths in accordance with the edge structure of the tree, in order to compute a reconstructed root hash 1004 (comparable to R′ in FIG. 5), which in turn can be compared with the hash value of the root node in order to verify the data block D₃.

FIG. 10 illustrates fact that, in order to perform a Merkle proof for the generalised hash tree, the same principles are applied as for a classical binary or non-binary Merkle tree. The Merkle path is still just the minimum set of hashes that are required to reach the root node and compare the reconstructed root hash 1004 to its known value.

In the example shown in FIG. 10, the Merkle proof (authentication path) is computed on a block of data D₃, whose hash² value is given by node P. To validate that this data block is a member of the data set represented by the tree, the hash values of nodes N, 0, Q, R, K, F, C, D are required in order.

By concatenating the reconstructed root hash 102 for node P with its siblings and hashing, a reconstructed hash value for node J is computed. This process is repeated until the root node A is reached, which should be equal to the expected Merkle root hash value (i.e. the hash value of the root node).

There are a number of interesting properties that emerge when examining Merkle proofs of existence used with generalised hash tree when compared to proofs using classical Merkle trees.

Property 1: Required number of hashes ² Which, as noted, is preferably a double-hash of the block D₃ at least for sensitive data.

Referring back to section 2.1.1, consider such a binary classical tree of depth M, representing N data blocks. In order to perform a Merkle proof of existence on any one of these data blocks, it will always require M=log₂ N hash values for a successful proof.

However, in the proposed generalised tree this is not the case. The number of hash values required to compute a proof of existence will vary according to: (i) the depth of the node; and (ii) the number of siblings of the node.

This means that, while in some cases a Merkle proof may require more hash values (and possibly more computation) than in a classical binary tree, in others a Merkle proof will require fewer hash values (therefore possibly less computation).

For example, take the hash tree of FIG. 10. This hash tree stores 14 data blocks, and so its binary tree counterpart would have N=16 leaf nodes (2 null or duplicated values) and a Merkle proof of existence on any of the data blocks would require exactly 4 hash values.

However, the hash tree of FIG. 10 is such that proving the existence of nodes C and D would require only 2 values (fewer than the binary tree), while it would require 8 for nodes N, O, P, Q or R.

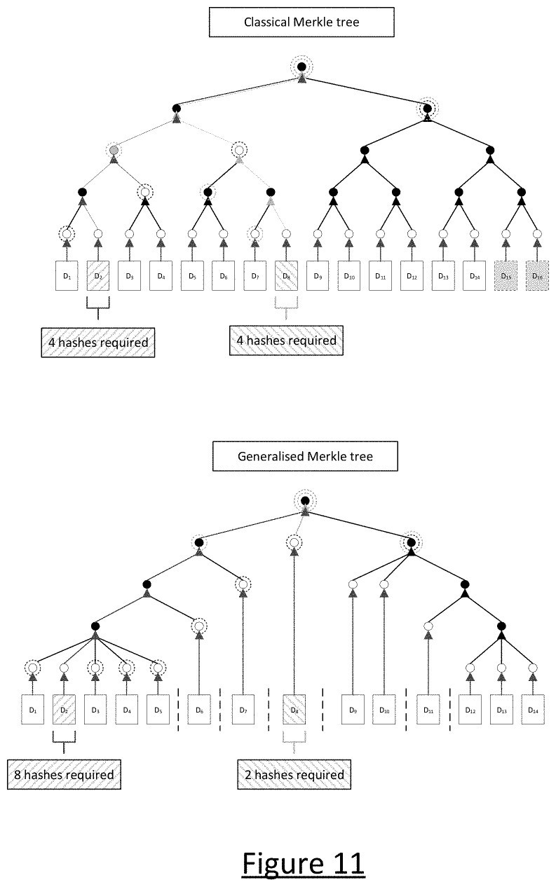

FIG. 11 shows a comparison of the varying number of hashes required for proofs in the generalised and classical Merkle tree constructions. This demonstrates the contrast in the number of required hashes between the generalised and classical Merkle tree constructions.

Property 2: Dual-Purpose Proofs

In classical Merkle trees, due to the fact that all leaf nodes are located at the bottom layer (m=M) of the tree, all Merkle proofs will require the same number of hash computations.

In other words, the number of times the ‘concatenate and hash’ operation is performed as part of a Merkle proof will be the same for each data leaf. For a tree of depth m=M, and where the root node is at m=0, each Merkle proof of existence will require exactly M such operations.

These operations are represented as arrows in FIG. 11. Each arrow represents the operation of concatenating a node with all its siblings and hashing to obtain the result.

The number of these operations (arrows) is a function only of the depth of the leaf node on which the Merkle proof of existence is being performed. This is why in a classical Merkle tree all proofs require M operations—all leaf nodes are at the bottom of the tree.

However, the generalised Merkle tree has been specified such that leaf nodes may exist at any level within the tree. This means that the number of operations involved in Merkle proofs will indeed vary, ranging from 1 to a maximum of M.

This distinction is evident in FIG. 11, where all Merkle proofs on the left-hand tree (classical) will require exactly m=M=4 operations, while in the right-hand tree (generalised) the number of operations varies from 4 for the bottom-level data packets to as few as 1 for the data packet D₈.

The very fact that the number of operations for Merkle proofs varies in the case of generalised hash trees means that these Merkle proofs can now be considered dual-purpose:

Purpose 1: A Merkle proof existence that enables a data packet D to be shown to be a member of a larger data set D without possessing the full data set.

Purpose 2: A Merkle proof of existence that enables a data packet D to be shown to exist at a particular level m in a hierarchy of data belonging to the set D.

Only the first of these purposes is applicable to standard Merkle proofs of existence implemented with a classical Merkle tree, whereas both apply to Merkle proofs performed on the generalised hash tree.

This is because not only does a Merkle proof for a generalised hash tree achieve the same proof of set membership as in the classical case, but the number of operations used in performing the proof also betrays the height (level) at which the data D is included in the hash tree.

When the data leaves form a hierarchy, the Merkle proof may then be used to show that the data was inserted in the tree at a given level m—if the proof comprises exactly m ‘concatenate and hash’ operations—and thus both set membership and hierarchical position within that set.

### 4. Example Blockchain Encoding

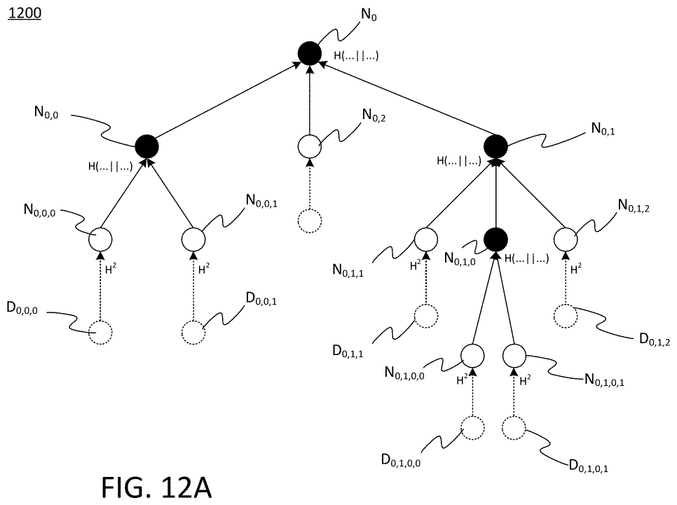

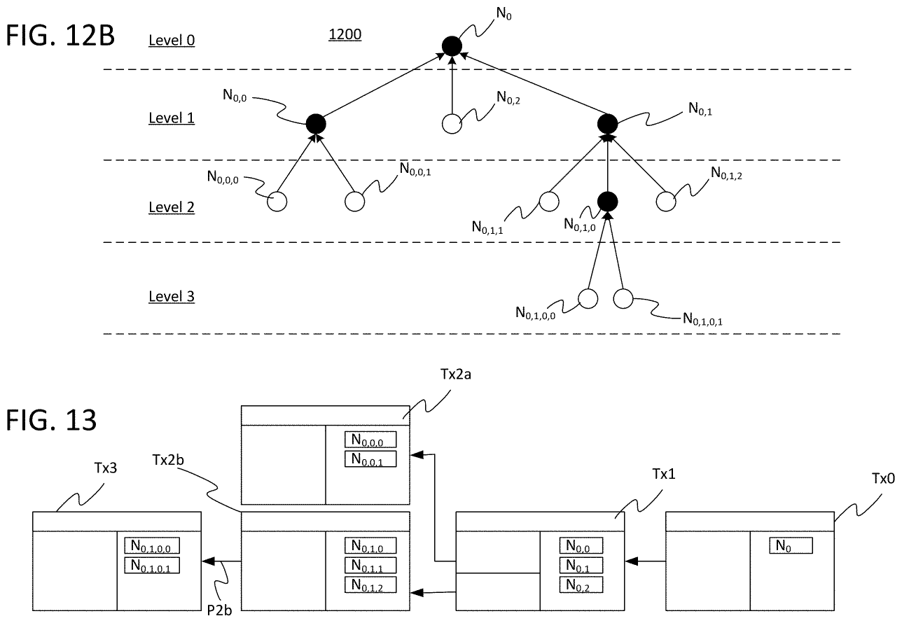

FIG. 12A shows a schematic block diagram of a data structure in the form of a generalised hash tree (referred to synonymously herein as a generalised Merkle tree). The generalised hash tree is denoted by reference numeral 1200 and is shown to comprise a plurality of nodes and edges structured in a manner that utilises the additional flexibility afforded by the generalised hash tree schema. It will be appreciated that this is merely one illustrative example and a generalised hash tree can take any form that meets the requirements set out above.

Each node in the generalised hash tree 1200 is represented by a circle and has a level which is defined by the number of edges that connect it to a common root node No. As is the case for all generalised hash trees, there is a single common root node No to which all other nodes are directly or indirectly connected. The root node No is the only node of the generalised hash tree having a level of zero.

The example of FIG. 12A shows three nodes at level 1. That is, three nodes which are directly connected to the root node No by a single directional edge from that node to the root node No. Of those three level 1 nodes, two are shown to be non-leaf nodes and the third is shown to be a leaf node (non-leaf nodes being any node to which at least one other node is directly connected by a directional edge, which in turn is referred to a child node of that leaf node; non-leaf nodes being any node without any child node in this sense).

A node indirectly connected to a parent node (i.e. connected to the parent node via one or more other nodes and thus by more than one directional edge) may be referred to as a grandchild node of the parent node. Each such parent node may be referred to as an ancestor of its children or grandchildren.

In the following description, the commas from each index tuple are omitted when unnecessary for disambiguation. So, for example, the notation N₀₀₁ is equivalent to N_{0,0,1} elsewhere in this description.

In accordance with the indexing system described above, the two non-leaf nodes at level 1 are denoted by N₀₀ and Not and the non-leaf node at level 1 is denoted by N₀₂.

Node N₀₀, in turn, has two child nodes denoted by N₀₀₀ and N₀₀₀₁. In the present example, both of those child nodes N₀₀₀ and N₀₀₁ happen to be leaf nodes having no child nodes of their own. These are at level 2 in the generalised hash tree, being connected to the root node N₀ via the level 1 node N₀₀ (the “parent” node of both node N₀₀₀ and N₀₀₁), each via a total of two directional edges (the edge from that node to the parent node N₀₀ and the directional edge from the parent node N₀₀ to the root node N₀).

Node Not is shown to have three child nodes at level 2, denoted by N₀₁₀, N₀₁₁ and N₀₁₂. One of those child nodes is itself a non-leaf node, and in accordance with the above indexing scheme has the lowest sibling index of zero (i.e. the non-leaf child node is node N₀₁₀). That node, in turn, is shown to have two child nodes at level 3 in the hash tree 1200, denoted by N₀₁₀₀ and N₀₁₀₁, both of which happen to be leaf nodes in the present example. Each of those level 3 child nodes is connected to the root node No indirectly via their parent node N₀₁₀ and its own parent node N₀₁, via a total of three directional edges.

The remaining child nodes of node N₀₁, i.e. nodes N₀₁₁ and N₀₁₂, are leaf nodes with no child nodes of their own.

Each leaf node is represented as a white circle and each non-leaf node, including the root node N₀, is represented as a black circle. The hash value of each leaf node is a double hash of a data block, such as a document, file etc. In general, a data block can take any form and simply refers to the pre-image which is double hashed in order to obtain the hash value of a leaf node. Each directional edge is denoted by a solid arrow from a child node to a parent node.

The notation Dᵢ is used to denote the data block which is double hashed in order to obtain the hash value of node Nᵢ where i denotes an index tuple of that non-leaf node. As per the above schema, the length of the index tuple increases with the level of the node. So, for example, the data block hashed to compute the hash value of node N₀₁₀₀ is denoted by D₀₁₀₀ and the data block hashed to obtain the hash value of leaf node N₀₀₁ is denoted by D₀₀₁ etc. Each such data block is represented in FIG. 12A by a circle having a dotted outline (note: this is not a node of the generalised hash tree according to the definitions used herein), and a dotted arrow is used to represent the relationship between a data block and the corresponding leaf node (note: this is not an edge of the data structure according to the definitions used herein). The double hashing relationship between data blocks and non-leaf nodes is denoted by the operator H².

As per the above schema, the hash value of each non-leaf node is a single hash of a pre-image, that pre-image being in the form of a concatenated string formed by concatenating the hash values of all of its child nodes. So, by way of example, the hash value of node N₀₀ is a hash of a concatenation of the hash values of its child nodes, i.e. node N₀₀₀ and N₀₀₁. This is denoted in FIG. 12A by H( . . . ∥ . . . ), noting that the concatenation is over all child nodes, of which there can be any number.

The generalised hash tree schema is flexible enough to admit parent nodes with a single child node—in that case, the hash value of the parent nodes is a hash of the hash value of the single child node.

In the example of FIG. 12A, both of the child nodes of node N₀₀ happen to be leaf nodes. However, the generalised hash tree schema also admits non-leaf nodes whose child nodes are a mixture of leaf and non-leaf nodes. Node N₀₁ falls into this category and its hash value is a hash of a concatenation of the hash value of its non-leaf child node N₀₁₀ with the hash values of its leaf child nodes N₀₁₁ and N₀₁₂.

The hash value of the non-leaf child node N₀₁₀, is, in turn, a hash of a concatenation of the hash values of its child nodes N₀₁₀₀ and N₀₁₀₁ (both of which happen to be leaf nodes in this example, and which are thus derived as a double hash of corresponding data blocks D₀₁₀₀ and D₀₁₀₁).

The test value of a given leaf or non-leaf node Nᵢ may be denoted Hᵢ herein. Note, however, that elsewhere in this disclosure, the notation Hᵢ may be used to represent the hash value itself. The meaning should be clear in context.

The nodes N₀₁₀₀ and N₀₁₀₁ are grandchildren of the nodes N₀₁ and N₀₁. The nodes N₀₀₀ and N₀₀₁ are grandchildren of the root node N₀ only.

FIGS. 12B and 13 show how the generalised hash tree 1200 of FIG. 12A may be embodied in a sequence of blockchain transactions.

FIG. 12B shows the same generalised hash tree 1200 marked to show the levels of its constituent nodes. The data blocks are omitted from FIG. 12B (and in any event, as noted, these do not form part of the generalised hash tree 1200, and the data blocks themselves are not stored on the blockchain in this example).

FIG. 13 shows a set of blockchain transactions which may be used to encode and store the generalised hash tree 1200 in a block chain. In this example encoding, a transaction Tx₀ (the root transaction) is used to represent the root node N₀.

In addition to the root transaction Tx0, one transaction is used to represent each set of sibling nodes, i.e. all nodes having the same parent node are grouped together in one transaction in this example.

Hence, in this example, the three child nodes of the root node N₀, namely N₀₀, N₀₁ and N₀₂ are encoded in a single transaction Tx1 referred to as a level-1 transaction (reflecting the fact that those nodes being at level 1 in the tree).

There are two level-2 transactions denoted by reference signs Tx2a and Tx2b respectively. The first level-2 transaction Tx2a encodes the child nodes of the level one node N₀₀, i.e. nodes N₀₀₀ and N₀₀₁. Likewise, the second level-2 transaction Tx₂b encodes the three child nodes of node N₀₁, i.e. nodes N₀₁₁, N₀₁₀ and N₀₁₂.

A single level-3 transaction Tx3 encodes the children of node N₀₁₀, i.e. nodes N₀₁₀₀ and N₀₁₀₁.

In each of the transactions Tx0 to Tx3, the hash value or values of the node or nodes encoded by that transaction are contained in one or more outputs of that transaction. That is to say, each node hash value is directly encoded in an output of that transaction, and in the case of a transaction representing multiple nodes, the hash values of those nodes may be explicitly contained in the same output or in different outputs of that transaction.

In one implementation, the hash values are contained in un-spendable outputs of the transactions Tx0 to Tx3, for example using OP_DROP or OP_RETURN.

As another example, the hash values may be contained as dummy operands of a check multi-signature operand (CHECKMULTISIG).

Each of the transactions Tx0 to Tx3 has at least one spendable output (which may or may not be the output in which any node hash value is contained). The directional edges of the generalised hash tree 1200 are encoded as spending relationships between the transactions.

Starting with the level-3 transaction Tx3, this transaction has a spendable output which is spent by the second level-2 transaction Tx2b. That is to say, an input of the second level-2 transaction Tx2b contains a pointer to that output of the level-3 transaction Tx3 denoted by reference sign P2b. This pointer P2b not only encodes the spending relationship between the second level-2 transaction Tx2b and the level-3 transaction Tx3, but also encodes the two directional edges from the non-leaf node N₀₁₀ at level two (encoded in transaction Tx2b) and its two child nodes N₀₁₀₀ and N₀ₘ (both encoded in transaction Tx₃).

The level one transaction Tx1 has at least two inputs, one of which spends an output of the first level one transaction Tx2a and the other of which spends a spendable output of the second level two transaction Tx2b. This captures the relationship between the level one nodes encoded in the level one transaction Tx1 and the level two nodes encoded in the level two transaction Tx2a and Tx2b. Tx2a encodes all of the child nodes of the level one node N₀₀, and the second level two transaction encodes all of the child nodes of the level one node N₀₁.

Finally, the root transaction Tx0 encodes the hash value of the root node, and the root transaction Tx0 has at least one input which spends a spendable output of the level one transaction Tx1.

Depending on the implementation, to some extent the mathematical properties of cryptographic hash functions may be harnessed to encode structure of the hash tree. For example, for a transaction containing multiple summary hashes, it is always possible to resolve each summary hash to a subset of a known set of nodes one level below because there will only exist a single subset of nodes whose concatenated hash equals the summary hash. Hence, even when a transaction contains multiple summary hashes, it is not essential to explicitly map those summary hashes to respective subsets of child nodes at the next level down because that information is already captured in their mathematical properties, and can therefore be inferred from the data unambiguously. Relying on the mathematical properties of the hash values may be more memory efficient because it reduces the amount of redundant data in the transactions.

However, as an alternative, a degree of redundant data may be introduced, which may be somewhat less memory-efficient but, on the other hand, may allow the hash tree to be reconstructed/interpreted using less computing resource (i.e. more computationally-efficient). For example, the input script could more modified such that the nodes that go into each summary hash are separated by an appropriate (arbitrary) marker (e.g. OP_0 or any other arbitrary marker such as a <data> push) and ensuring the order (i.e. left-to-right as they are drawn) of the separated sets of nodes corresponds to the order of the summary hashes.

For example, for summary hashes H₀₀ and H₀₁, the input unlocking script of Tx, might read as

H(D₀₀₁)OP_0H(D₀₁₁)H(D₀₁₂)

Or

H(D₀₀₁)<separation data>H(D₀₁₁)H(D₀₁₂)

etc.

This conveys the fact that D₀₀₁ is the missing input to the summary hash H₀₀ because H₀₀ is the first summary hash in the output script of Tx. I.e. the consistent ordering of data between the input and output of the transaction is useful for interpreting the transaction data in a computationally efficient manner.

5. On-Chain Vs. Off-Chain Representation

The set of transactions Tx0-Tx3 of FIG. 13 is an “on-chain” encoding, in that the transactions may be submitted to a node of the blockchain transaction and mined into one or more blocks 151 at some point thereafter.

In the present example, indices calculated according to the above indexing scheme are not explicitly encoded in the blockchain transaction Tx0-Tx3, rather the hierarchical relationships between the nodes of the data structure 1200 are encoded as spending relationships between those transactions (which, in turn, are captured as pointers between those transactions).

The indexing scheme may be implemented off-chain as part of an initial off-chain representation of the data structure 1200, either prior to committing the data structure 1200 to the blockchain, or after it has been committed in order to re-construct it off-chain.

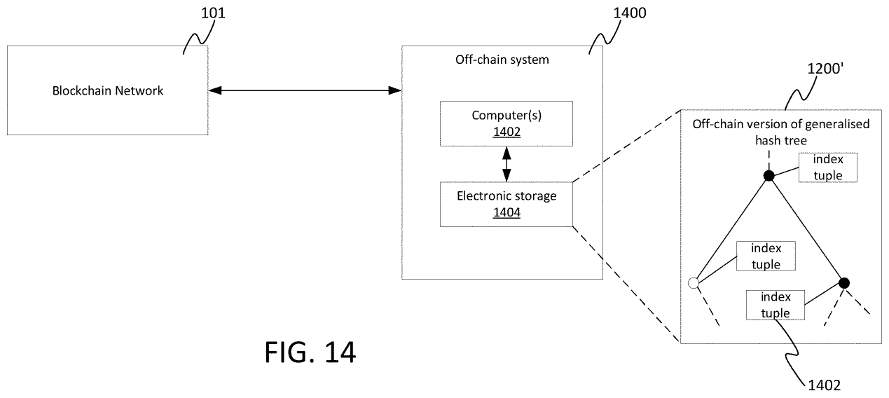

FIG. 14 shows a highly schematic block diagram of an off-chain system 1400, shown to comprise one or more computers 1402 having access to electronic storage 1404 of the off-chain system 1400 (off-chain storage). Each computer comprises one or more computer processors such as a general-purpose processor (CPU, GPU/accelerator processor etc.) and or a programmable or non-programmable special-purpose processor such as an FPGA, ASIC etc. for carrying out the described functions of the off-chain system 1400. The off-chain system 1404 is operable to communicate with at least one node of the blockchain network 101, in order to do one or both of: submitting one of more of the transactions Tx0-Tx3 to the blockchain network 101 for recording in the blockchain 150 for the purpose of committing the generalised hash tree data structure 1200 to the blockchain 150, and retrieving one or more the transactions TX0-Tx3 for the purpose of re-constructing the generalised hash tree data structure 1200 therefrom in the off-chain storage 1404.

In both cases, a version of the generalised hash tree 1200 is maintained at least temporarily in the off-chain storage 1404. In order to implement the operations described above—either to construct the node tree according to the node equations or to verify a received data tree using a Merkle proof—each node of the version of the generalised hash tree 1200 in the off-chain storage 1404 may be assigned an index tuple calculated in accordance with the above indexing scheme (Rules 6 to 8 above).

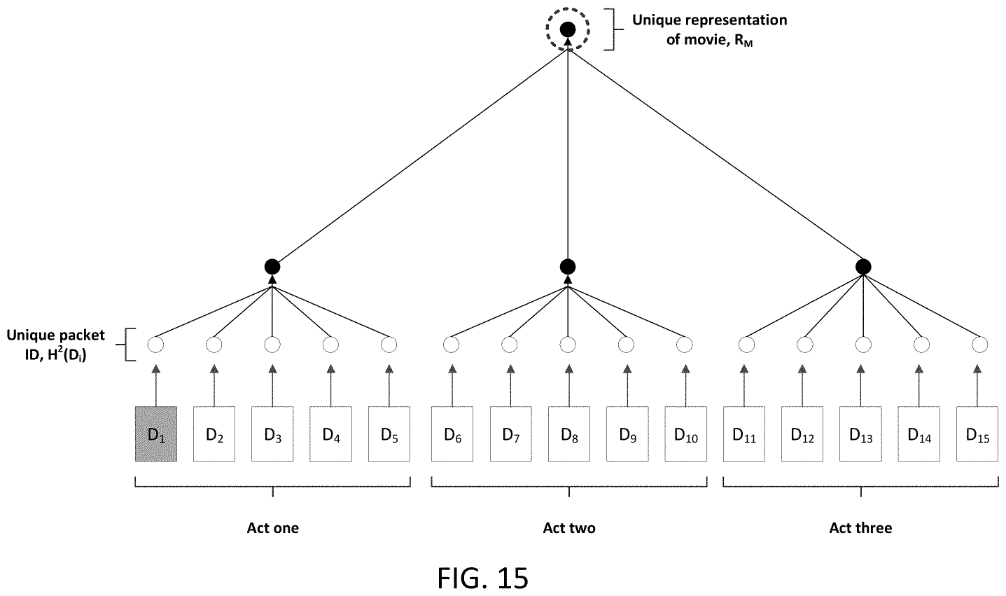

In FIG. 15, the version of the generalised hash tree 1200 stored in the off-chain storage 1400 (off-chain version) is denoted by reference sign 1200′. As indicated, each node thereof is associated with an explicitly calculated index tuple 1402.

Alternatively or additionally, each index tuple may be explicitly encoded in the blockchain transactions TX0-TX3 themselves. This is by no means essential, but assist in interpreting the transaction data. For example, if all of the indexes are encoded explicitly then a processing entity may be able to work out how all the data fits together in the tree without knowing the ‘rules’ beforehand.

6. Use case: Streaming a Movie

The use of a generalised hash tree structure to represent the creation of a copyright work, combined with a blockchain to immutably timestamp the order of operations, may be applied to scenarios involving the creation of many different types of work.

One such example would be the creation of a movie, which will typically involve many parties such as a director, producers, screen-writers, actors, set-designers, and editors.

The described example considers a movie but the description applied equally to any other form of digital content comprised of discrete segments.

Generalised hash tree for a movie

A highly-complex hash tree could be made to represent the creative process in its entirety, detailing how each element of the final movie has been created.

However, for this example a simplified scenario is considered. It is assumed the film-making process is split into the creation of three acts of equal length. Each act is in turn split into five chunks of equal length, such that the entire movie comprises 15 chunks of video data in total D₁, . . . , D₁₅, each of which has an associated double-hash value H²(Dᵢ). The movie can then be represented using a simple generic hash tree as shown in FIG. 15.

FIG. 15 shows a generalised hash tree structure applied to a movie, split into 15 data segments.

As discussed in section 6.3 below, the double-hash value associated with each chunk of the film can be used as a unique packet ID, and each packet can be quickly verified as part of this hash tree by using its Merkle root R_{M} as a unique identifier for the entire film. In this sense, the root R_{M} acts in a similar way to an ISBN or barcode as a unique identifier for the product.

However, the root R_{M} is far more valuable as a unique product identifier than a traditional barcode, because it also enables the individual components of the film to be verified easily, provided there is a trusted source for R_{M} itself.

Moreover, it is possible to associate each segment of the film D₁, . . . , D₁₅ with the root of another, separate generalised hash sub-tree. This is how the individual components of each segment can be tracked on the blockchain using the copyright assignment implementation described in section 4.

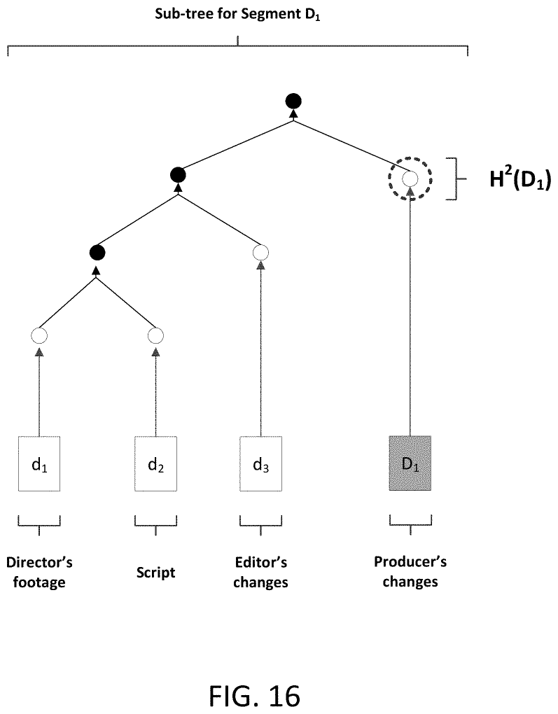

An example of such a generalised hash sub-tree for the first movie segment D₁ is shown in FIG. 16. In both FIGS. 15 and 16 the data segment for D₁ is shown in green for consistency, however, the two trees themselves are separate instances of a copyright assignment hash tree.

FIG. 16 shows A generalised hash sub tree for the first movie segment D₁. The data that is combined to eventually produce the segment D₁ are shown in lower case.

Streaming the Movie

For a movie represented by a hash tree of the kind shown in FIG. 15, one example of a practical application is a scenario in which a consumer (Alice) can use the generalised hash tree as a powerful data integrity check when streaming the movie from a streaming service provider (Bob).

When Alice wishes to stream the film, she could first retrieve the Merkle root R_{M}, which is used as the public unique identifier for the movie file. In addition to this, she should also retrieve the unique packet IDs H²(D₁), . . . , H²(D₁₅) and the relevant Merkle paths Γ₁, . . . , Γ₁₅ for each of the 15 movie segments. It is assumed that all of this information is publicly available on the blockchain 150 (see section 4) and have been certified by a standards body, such as the British Board of Film Classification (BBFC) in the UK [14]. The data Alice wants to stream, and the data Alice has ahead of time, are shown in the table 6 below.

TABLE 2
The data Alice requires to safely stream
the movie from a network peer.

| | |
|---|---|
| Segments Requested | Data Obtained |
| (while streaming) | (beforehand) |

| | | |
|---|---|---|
| D₁ | H²(D₁) | Γ₁ |
| D₂ | H²(D₂) | Γ₂ |
| . . . | . . . | . . . |
| D₁₅ | H²(D₁₅) | Γ₁₅ |

This means that Alice now has enough information to verify whether the data packets she is sent by the Bob, as the streaming service provider, are legitimate without needing to watch them herself. If Alice receives a packet that does not double-hash to the or any packet ID she can disregard the data as incorrect and terminate her viewing.

If combined with a pay-per-second payment framework, this would provide Alice with an extremely low-risk way to stream content on a peer-to-peer basis.

With an appropriate granularity in segment size, Alice is also protected from accidentally viewing indecent or unexpected content because she can enforce that the unique packet ID is always checked before watching and segment. This could be made as strict as a frame-by-frame pre-checking of packet IDs.

Updating the Version of a Movie

The ability to have a fixed, unique product identity—the root of a Merkle tree—is particularly useful for application to the creation of movies, which will often have multiple different versions. For instance, a movie will often have to be slightly modified for each country it is screened in to comply with local regulations.

These small modifications may be hard to distinguish for a human user such as Alice, but they will always be easy to detect in the hash digest of the movie data, due to the high-entropy properties of cryptographic hash functions.

Consider the same movie as above, which has 15 segments with unique packet IDs all connected inextricably to the unique product identity for the movie that is the Merkle tree root R_{M}.

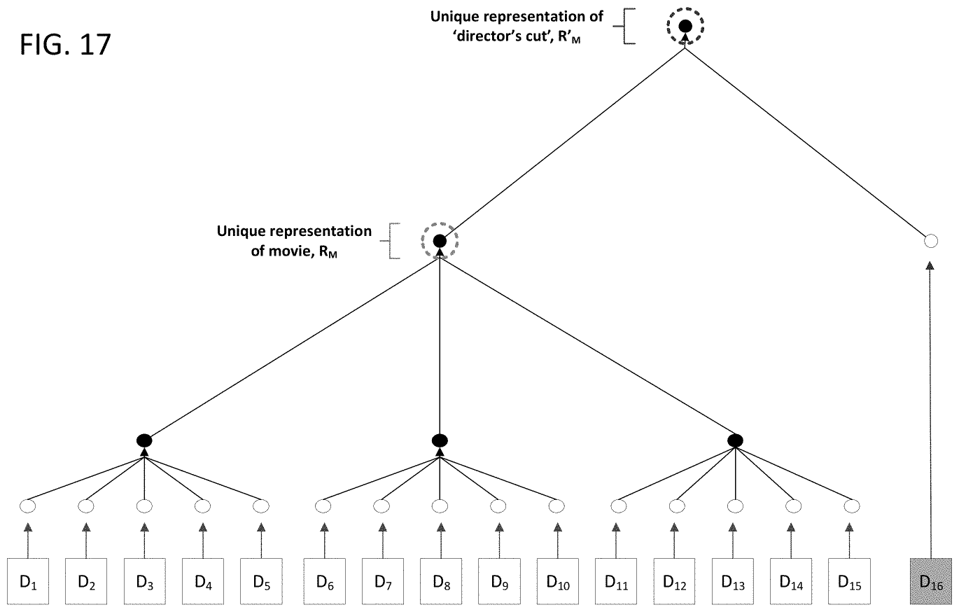

It is feasible that the director revisits this movie several years later to make some minor editorial changes for a special ‘director's cut’ edition of the movie. The effect of the director's new changes to the movie are shown in FIG. 17.

FIG. 17 shows a modified generalised hash tree representing the new ‘director's cut’ version of the movie. The director's changes to the original are shown (red) in the data segment D₁₆.

The new generalised hash tree must necessarily have a new root R_{M}′ #R_{M}, which means the ‘director's cut’ version is easily distinguishable from the original version by employing the convention of using the root of the hash tree as the unique product identifier for the entire film.

This new identifier allows Alice to verify whether she is watching the expected version of the movie before she watches a single frame. If Alice is receiving data packets for the director's cut but is trying to verify them against the original film's product ID, then even the first segment will fail and she knows to ask Bob instead for the original version.

This check can also be used as a tool for users of peer-to-peer streaming services to ensure that they do not inadvertently stream a version of a movie that has been banned in their home country.

It will be appreciated that the above embodiments have been described by way of example only.

More generally there may be provided a method, apparatus or program in accordance with any one or more of the following Statements.

Statement 1. According to a first aspect disclosed herein there is provided data structure embodied in one or more blockchain transactions held in transitory or non-transitory computer-readable media, the data structure having: a plurality of nodes, each node embodied as a hash value contained in a blockchain transaction of the one or more blockchain transactions; and a plurality of directional edges; wherein the plurality of nodes comprises leaf nodes and non-leaf nodes, every non-leaf node having at least one child node directly connected thereto by a directional edge, and every child node being a non-leaf node or a leaf node without any child node connected thereto, the non-leaf nodes including a common root node to which all other nodes are connected directly or indirectly via one or more of the non-leaf nodes; wherein the hash value of each non-leaf node is a hash of a concatenation of the hash values of all of its child node(s), and wherein the hash value of each leaf node is a hash of an external data block; and wherein at least one of the non-leaf nodes has at least one child leaf node and at least one child non-leaf node, the hash value of the at least one non-leaf node being a hash of a concatenation of the respective hash values of the child leaf node and the child non-leaf node.

Herein the term “hash of a concatenation of hash values” refers to the mathematical properties of the hash value to which the term applies, and therefore admits a variety of different methods for actually computing the hash value with those mathematical properties from the underling data (including, for example, methods that add padding bits in a predictable manner etc.).

### Example Embodiments of the Method of Statement 1 Include the Following

Statement 2. The data structure of Statement 1, wherein a first of the non-leaf nodes has a different number of child nodes connected thereto than a second of the non-leaf nodes.

Statement 3. The data structure of Statement 1 or 2, wherein a first of the leaf nodes has a different level than a second of the leaf nodes, the level of each node being the number of directional edges via which the node is directly or indirectly connected to the common root node.

Statement 4. A second aspect disclosed herein provides a structure embodied in one or more blockchain transactions held in transitory or non-transitory computer-readable media, the data structure having: a plurality of nodes, each node embodied as a hash value contained in a blockchain transaction of the one or more blockchain transactions; and a plurality of directional edges; wherein the plurality of nodes comprises leaf nodes and non-leaf nodes, every non-leaf node having at least one child node directly connected thereto by a directional edge, and every child node being a non-leaf node or a leaf node without any child node connected thereto, the non-leaf nodes including a common root node to which all other nodes are connected directly or indirectly via one or more of the non-leaf nodes; wherein the hash value of each non-leaf node is a hash of a concatenation of the hash values of all of its child node(s), and wherein the hash value of each leaf node is a hash of an external data block; and wherein a first of the non-leaf nodes has a different number of child nodes than a second of the non-leaf nodes.

Statement 5. A third aspect provides a data structure embodied in one or more blockchain transactions held in transitory or non-transitory computer-readable media, the data structure having: a plurality of nodes, each node embodied as a hash value contained in a blockchain transaction of the one or more blockchain transactions; and a plurality of directional edges; wherein the plurality of nodes comprises leaf nodes and non-leaf nodes, every non-leaf node having at least one child node directly connected thereto by a directional edge, and every child node being a non-leaf node or a leaf node without any child node connected thereto, the non-leaf nodes including a common root node to which all other nodes are connected directly or indirectly via one or more of the non-leaf nodes; wherein the hash value of each non-leaf node is a hash of a concatenation of the hash values of all of its child node(s), and wherein the hash value of each leaf node is a hash of an external data block; and wherein a first of the leaf nodes has a different level than a second of the leaf nodes, the level of each node being the number of directional edges via which the node is directly or indirectly connected to the common root node.

Further example embodiments of the above aspects are set out below.

Statement 6. The data structure of any preceding Statement, wherein: (i) each node directly or indirectly connected to the common root node is associated with a sibling index denoting a position of the node relative to any sibling nodes thereof, sibling nodes being child nodes of a common parent node; and (ii) each node indirectly connected to the common root node is associated with one or more intermediary indices identifying the one or more non-leaf nodes via which the node is indirectly connected to the common root node.

Statement 7. The data structure of Statement 6, wherein the index or indices associate with each node are directly encoded in the one or more blockchain transactions.

Statement 8. The data structure of Statement 6, wherein the index or indices associate with each node are not directly encoded in the one or more blockchain transactions but are stored in an off-chain data store.

Statement 9. The data structure of any preceding Statement, wherein the hash value of each leaf node is a double hash or other multi-hash of the external data block.

Statement 10. A computer-implemented method of creating or updating the data structure of any preceding Statement, the method comprising: receiving an external data block to be represented in the data structure; applying at least one hash function to the external data block to compute a hash value therefrom; and generating or modifying a blockchain transaction of the one or more blockchain transactions, the generated or modified blockchain transaction containing the hash value, and thereby creating a leaf node, within the data structure, representing the received external data block.

Statement 11. The method of Statement 10, the steps of which are performed for each leaf node of the data structure so as to create the data structure.

Statement 12. The method of Statement 10 or 11, comprising the step of transmitting the blockchain transaction to a node of a blockchain network for causing the node to process the blockchain transaction for recording in a blockchain.

Statement 13. The method of Statement 10 or 11, comprising the step of sending the blockchain transaction to an off-chain system for processing.

Statement 14. A computer-implemented method of verifying a received data block using the data structure of any of Statements 1 to 7, the method comprising: receiving the data block to be verified, the received data block corresponding to one of the leaf nodes; applying at least one hash function to the received data block, thereby computing a reconstructed leaf node hash; determining, from the data structure, an authentication path for the external data block, the authentication path being a set of one or more of the nodes required to reconstruct the hash value of the common root node; computing a reconstructed root node hash using the reconstructed leaf node hash and the hash value(s) of the one or more nodes of the authentication path, by applying successive hashing and concatenating operations in accordance with the directional edges between those nodes; and comparing the reconstructed root node hash with the hash value of the common root node, and thereby verifying the received data block.

Statement 15. The method of any of Statements 10 to 14, comprising calculating: (i) for each node directly or indirectly connected to the common root node, a sibling index denoting a position of the node relative to any sibling nodes thereof, sibling nodes being child nodes of a common parent node and (ii) for each node indirectly connected to the common root node, one or more intermediary indices identifying the one or more non-leaf nodes via which the node is indirectly connected to the common root node.

Such indexes may be computed as part of creation and/or authentication. In the context of authentication, the authentication path for the external data block would, in the case that the corresponding node is indirectly connected to the root node, correspond to the one or more non-leaf nodes via which that node is indirectly connected to the common root node.

Statement 16. The method of Statement 15, wherein the index or indices calculated for each node are directly encoded in the one or more blockchain transactions.

Statement 17. The method of Statement 15, wherein the calculated indices are not directly encoded in the one or more blockchain transactions but are stored are an off-chain datastore.

Statement 18. The method of any of Statements 15 to 17 when dependent on Statement 10, wherein, in order to create the data structure, the hash value N_{0,i}_{_{0, . . . ,}}ᵢ_{_{m−2}}_{,j} of each non-leaf node is computed as:

$${N}_{0 , {i}_{0} , … , {i}_{m - 2} , j} = H ( {\sum }_{α = 0}^{n - 1} {N}_{0 , {i}_{0} , … , {i}_{m - 2} , j , α} )$$

wherein i₀, . . . , iₘ₋₂ represents any intermediary index or indices of the non-leaf node, N_{0,i}_{_{0, . . . ,}}ᵢ_{_{m−2}}_{,j,α} is the hash value of a child node of the non-leaf node with i₀, . . . , iₘ₋₂,j representing the one or more intermediary indices of the child node, j being the sibling index of the non-leaf node and also the final intermediary index of the child node, and a being the child node's sibling index; wherein Σ_{α=0}ⁿ⁻¹N_{0,i}_{_{0, . . . ,}}ᵢ_{_{m−2}}_{,j, α} denotes concatenation of the hash values of all child nodes of the non-leaf node; and wherein H is a hash function.

Statement 19. The method of any of Statements 15 to 18 when dependent on Statement 14, wherein the index or indices calculated for the node(s) of the authentication path and the node corresponding to the received data block are used in computing the reconstructed root node hash, by computing the hash value N_{0,i}_{_{0, . . . ,}}ᵢ_{_{m−2}}_{,j} of each node of the authentication path is as:

$${N}_{0 , {i}_{0} , … , {i}_{m - 2} , j} = H ( {\sum }_{α = 0}^{n - 1} {N}_{0 , {i}_{0} , … , {i}_{m - 2} , j , α} ) ,$$

wherein i₀, . . . , iₘ₋₂ represents any intermediary index or indices of the non-leaf node, N_{0,i}_{_{0, . . . ,}} ᵢ_{_{m−2}}_{,j,α} i: the hash value of a child node of the non-leaf node if the child node forms part of the authentication path, and the reconstructed leaf node hash if the child node is the leaf node corresponding to the received data block to be verified, with i₀, . . . , iₘ₋₂,j representing the one or more intermediary indices of the child node, j being the sibling index of the non-leaf node and also the final intermediary index of the child node, and a being the child node's sibling index; wherein Σ_{α=0}ⁿ⁻¹N_{0,i}_{_{0, . . . ,}} ᵢ_{_{m−2}}_{,j,α} denotes concatenation of the hash values of all child nodes of the non-leaf node; and wherein H is a hash function.

Statement 20. A computer system comprising one or more computer processors and computer-readable media coupled to the one or more computer processors for embodying the data structure of any of Statements 1 to 13, wherein the one or more computer processors are configured to implement the method of any of Statements 14 to 19.

Statement 21. Computer-readable program instructions embodied on transitory or non-transitory media and configured, when executed on one or more computer processors, to implement the method of any of Statements 14 to 19.

According to another aspect disclosed herein, there may be provided a method comprising the actions of the first party, second party, any third party that may be involved, and/or any one or more of the network of nodes.

According to another aspect disclosed herein, there may be provided a system comprising the computer equipment of the first party, the computer equipment of the second party, the computer equipment of any third party, and/or any one or more of the network of nodes.

Other variants or use cases of the disclosed techniques may become apparent to the person skilled in the art once given the disclosure herein. The scope of the disclosure is not limited by the described embodiments but only by the accompanying claims.

1. A non-transitory computer-readable media storing a data structure embodied in one or more blockchain transactions held in the non-transitory computer-readable media, the data structure having:
a plurality of nodes, each node embodied as a hash value contained in a blockchain transaction of the one or more blockchain transactions; and
a plurality of directional edges;
wherein the plurality of nodes comprises leaf nodes and non-leaf nodes, every non-leaf node having at least one child node directly connected thereto by a directional edge, and every child node being a non-leaf node or a leaf node without any child node connected thereto, the non-leaf nodes including a common root node to which all other nodes are connected directly or indirectly via one or more of the non-leaf nodes;
wherein the hash value of each non-leaf node is a hash of a concatenation of the hash values of all of its child node(s), and wherein the hash value of each leaf node is a hash of an external data block; and
wherein the data structure is configured to have at least one of:
at least one of the non-leaf nodes having at least one child leaf node and at least one child non-leaf node, the hash value of the at least one non-leaf node being a hash of a concatenation of the respective hash values of the child leaf node and the child non-leaf node;
a first of the non-leaf nodes having a different number of child nodes than a second of the non-leaf nodes; and
a first of the leaf nodes having a different level than a second of the leaf nodes, the level of each node being the number of directional edges via which the node is directly or indirectly connected to the common root node.

2. The non-transitory computer-readable media of claim 1, wherein a first of the non-leaf nodes has a different number of Child nodes connected thereto than a second of the non-leaf nodes.

3. The non-transitory computer-readable media of claim 1, wherein a first of the leaf nodes has a different level than a second of the leaf nodes, the level of each node being the number of directional edges via which the node is directly or indirectly connected to the common root node.

4-5. (canceled)

6. The non-transitory computer-readable media of claim 1, wherein:
(i) each node directly or indirectly connected to the common root node is associated with a sibling index denoting a position of the node relative to any sibling nodes thereof, sibling nodes being child nodes of a common parent node; and
(ii) each node indirectly connected to the common root node is associated with one or more intermediary indices identifying the one or more non-leaf nodes via which the node is indirectly connected to the common root node.

7. The non-transitory computer-readable media of claim 6, wherein the index or indices associate with each node are directly encoded in the one or more blockchain transactions.

8. The non-transitory computer-readable media of claim 6, wherein the index or indices associate with each node are not directly encoded in the one or more blockchain transactions but are stored in an off-chain data store.

9. The non-transitory computer-readable media of claim 1, wherein the hash value of each leaf node is a double hash or other multi-hash of the external data block.

10. A computer-implemented method of creating or updating a data structure, wherein the data structure is embodied in one or more blockchain transactions held in transitory or non-transitory computer-readable media, the data structure having:
a plurality of nodes, each node embodied as a hash value contained in a blockchain transaction of the one or more blockchain transactions; and
a plurality of directional edges;
wherein the plurality of nodes comprises leaf nodes and non-leaf nodes, every non-leaf node having at least one child node directly connected thereto by a directional edge, and every child node being a non-leaf node or a leaf node without any child node connected thereto, the non-leaf nodes including a common root node to which all other nodes are connected directly or indirectly via one or more of the non-leaf nodes;
wherein the hash value of each non-leaf node is a hash of a concatenation of the hash values of all of its child node(s), and wherein the hash value of each leaf node is a hash of an external data block; and
wherein the data structure is configured to have at least one of:
at least one of the non-leaf nodes having at least one child leaf node and at least one child non-leaf node, the hash value of the at least one non-leaf node being a hash of a concatenation of the respective hash values of the child leaf node and the child non-leaf node;
a first of the non-leaf nodes having a different number of child nodes than a second of the non-leaf nodes; and
a first of the leaf nodes having a different level than a second of the leaf nodes, the level of each node being the number of directional edges via which the node is directly or indirectly connected to the common root node, the method comprising:
receiving an external data block to be represented in the data structure;
applying at least one hash function to the external data block to compute a hash value therefrom; and
generating or modifying a blockchain transaction of the one or more blockchain transactions, the generated or modified blockchain transaction containing the hash value, and thereby creating a leaf node, within the data structure, representing the received external data block.

11. The method of claim 10, the steps of which are performed for each leaf node of the data structure so as to create the data structure.

12. The method of claim 10, comprising the step of transmitting the blockchain transaction to a node of a blockchain network for causing the node to process the blockchain transaction for recording in a blockchain.

13. The method of claim 10, comprising the step of sending the blockchain transaction to an off-chain system for processing.

14. A computer-implemented method of verifying a received data block using a data structure, wherein the data structure is embodied in one or more blockchain transactions held in transitory or non-transitory computer-readable media, the data structure having:
a plurality of nodes, each node embodied as a hash value contained in a blockchain transaction of the one or more blockchain transactions; and
a plurality of directional edges;
wherein the plurality of nodes comprises leaf nodes and non-leaf nodes, every non-leaf node having at least one child node directly connected thereto by a directional edge, and every child node being a non-leaf node or a leaf node without any child node connected thereto, the non-leaf nodes including a common root node to which all other nodes are connected directly or indirectly via one or more of the non-leaf nodes;
wherein the hash value of each non-leaf node is a hash of a concatenation of the hash values of all of its child node(s), and wherein the hash value of each leaf node is a hash of an external data block; and
wherein the data structure is configured to have at least one of:
at least one of the non-leaf nodes having at least one child leaf node and at least one child non-leaf node, the hash value of the at least one non-leaf node being a hash of a concatenation of the respective hash values of the child leaf node and the child non-leaf node;
a first of the non-leaf nodes having a different number of child nodes than a second of the non-leaf nodes; and
a first of the leaf nodes having a different level than a second of the leaf nodes, the level of each node being the number of directional edges via which the node is directly or indirectly connected to the common root node, the method comprising:
receiving the data block to be verified, the received data block corresponding to one of the leaf nodes;
applying at least one hash function to the received data block, thereby computing a reconstructed leaf node hash;
determining, from the data structure, an authentication path for the external data block, the authentication path being a set of one or more of the nodes required to reconstruct the hash value of the common root node;
computing a reconstructed root node hash using the reconstructed leaf node hash and the hash value(s) of the one or more nodes of the authentication path, by applying successive hashing and concatenating operations in accordance with the directional edges between those nodes; and
comparing the reconstructed root node hash with the hash value of the common root node, and thereby verifying the received data block.

15. The method of claim 10, comprising calculating:
(i) for each node directly or indirectly connected to the common root node, a sibling index denoting a position of the node relative to any sibling nodes thereof, sibling nodes being child nodes of a common parent node, and
(ii) for each node indirectly connected to the common root node, one or more intermediary indices identifying the one or more non-leaf nodes via which the node is indirectly connected to the common root node.

16. The method of claim 14, further comprising calculating:
(i) for each node directly or indirectly connected to the common root node, a sibling index denoting a position of the node relative to any sibling nodes thereof, sibling nodes being child nodes of a common parent node, and
(ii) for each node indirectly connected to the common root node, one or more intermediary indices identifying the one or more non-leaf nodes via which the node is indirectly connected to the common root node.

17. (canceled)

18. The method claim 15, wherein, in order to create the data structure, the hash value N_{0,i}_{_{0, . . . ,}} ᵢ_{_{m−2}}_{,j-} each non-leaf node is computed as:
$${N}_{0 , {i}_{0} , … , {i}_{m - 2} , j} = H ( {\sum }_{α = 0}^{n - 1} {N}_{0 , {i}_{0} , … , {i}_{m - 2} , j , α} )$$
wherein i₀, . . . , iₘ₋₂ represents any intermediary index or indices of the non-leaf node, N_{0,i}_{_{0, . . . ,}} ᵢ_{_{m−2}}_{,j,α} is the hash value of a child node of the non-leaf node with i₀, . . . , iₘ₋₂, j representing the one or more intermediary indices of the child node j being the sibling index of the non-leaf node and also a final intermediary index of the child node, and a being the child node's sibling index;
wherein Σ_{α=0}ⁿ⁻¹N_{0,i}_{_{0, . . . ,}} ᵢ_{_{m−2}}_{,j,α} denotes concatenation of the hash values of all child nodes of the nor-leaf node; and
wherein H is a hash function.

19. The method of claim 16, wherein the index or indices calculated for the node(s) of the authentication path and the node corresponding to the received data block are used in computing the reconstructed root node hash, by computing the hash value N_{0,i}_{_{0, . . . ,}} ᵢ_{_{m−2}}_{,j} of each node of the authentication path is as:
$${N}_{0 , {i}_{0} , … , {i}_{m - 2} , j} = H ( {\sum }_{α = 0}^{n - 1} {N}_{0 , {i}_{0} , … , {i}_{m - 2} , j , α} ) ,$$
wherein i₀, . . . , iₘ₋₂ represents any intermediary index or indices of the non-leaf node,
the hash value of a child node of the non-leaf node if the child node forms part of the authentication path, and
the reconstructed leaf node hash if the child node is the leaf node corresponding to the received data block to be verified,
With i₀, . . . , iₘ₋₂, j representing the one or more intermediary indices of the child node, j being the sibling index of the non-leaf node and also a final intermediary index of the child node, and a being the child node's sibling index;
wherein Σ_{α=0}ⁿ⁻¹N_{0,i}_{_{0, . . . ,}} ᵢ_{_{m−2}}_{,j,α} denotes concatenation of the hash values of all child nodes of the non-leaf node; and
wherein H is a hash function.

20. (canceled)

21. A computer program product including computer-readable program instructions embodied on a non-transitory media and configured so that when the computer-readable program instructions are executed on one or more computer processors, the one or more computer processors are configured to verify a received data block using a data structure, wherein the data structure is embodied in one or more blockchain transactions held in transitory or non-transitory computer-readable media, the data structure having:
a plurality of nodes, each node embodied as a hash value contained in a blockchain transaction of the one or more blockchain transactions; and
a plurality of directional edges;
wherein the plurality of nodes comprises leaf nodes and non-leaf nodes, every non-leaf node having at least one child node directly connected thereto by a directional edge, and every child node being a non-leaf node or a leaf node without any child node connected thereto, the non-leaf nodes including a common root node to which all other nodes are connected directly or indirectly via one or more of the non-leaf nodes;
wherein the hash value of each non-leaf node is a hash of a concatenation of the hash values of all of its child node(s), and wherein the hash value of each leaf node is a hash of an external data block; and
wherein the data structure is configured to have at least one of:
at least one of the non-leaf nodes having at least one child leaf node and at least one child non-leaf node, the hash value of the at least one non-leaf node being a hash of a concatenation of the respective hash values of the child leaf node and the child non-leaf node;
a first of the non-leaf nodes having a different number of child nodes than a second of the non-leaf nodes; and
a first of the leaf nodes having a different level than a second of the leaf nodes, the level of each node being the number of directional edges via which the node is directly or indirectly connected to the common root node by perform steps including:
receiving a data block to be verified, the received data block corresponding to one of the leaf nodes;
applying at least one hash function to the received data block, thereby computing a reconstructed leaf node hash;
determining, from the data structure, an authentication path for the external data block, the authentication path being a set of one or more of the nodes required to reconstruct the hash value of the common root node;
computing a reconstructed root node hash using the reconstructed leaf node hash and the hash value(s) of the one or more nodes of the authentication path, by applying successive hashing and concatenating operations in accordance with the directional edges between those nodes; and
comparing the reconstructed root node hash with the hash value of the common root node, and thereby verifying the received data block.
